(19) United States
(12) Patent Application Publication
(10) Pub. No.: US 2015/0021505 A1
(43) Pub. Date: Jan. 22, 2015

(54) LEVER TYPE SWITCHING VALVE

(71) Applicant: CKD CORPORATION, Komaki-shi (JP)

(72) Inventors: Shinichi NITTA, Komaki-shi (JP); Takashi YAJIMA, Komaki-shi (JP)

(21) Appl. No.: 14/469,010

(22) Filed: Aug. 26, 2014

Related U.S. Application Data
(63) Continuation of application No. PCT/JP2013/053711, filed on Feb. 15, 2013.

(30) Foreign Application Priority Data
Feb. 27, 2012 (JP) 2012-039662

(51) Int. Cl. F16K 31/524; F16K 31/528

(52) U.S. Cl. CPC F16K 31/52408; F16K 31/528
USPC 251/235

(57) ABSTRACT

An inlet flow passage, a valve seat section, and a valve chamber are formed within a flow passage block. An operation chamber, a rocking chamber, and a drive chamber are formed within a case along a reference plane. A valve rod is brought into contact with and separated from the valve seat section by reciprocating through the operation chamber in an extending direction thereof. A piston rod reciprocates through the drive chamber in an extending direction thereof. A lever member is received in the rocking chamber and has a support shaft section. The distance between the center of the support shaft section and a second contact position where the piston rod contacts the lever member is set greater than the distance between the center of the support shaft section and a first contact position where the valve rod contacts the lever member.

### CLAIM OF PRIORITY

This application is a Continuation of International Patent Application No. PCT/JP2013/053711, filed on Feb. 15, 2013, which claims priority to Japanese Patent Application No. 2012-039662, filed on Feb. 27, 2012, each of which is hereby incorporated by reference.

### BACKGROUND OF THE INVENTION

1. Field of the Invention

The present invention relates to a lever type switching valve for switching over the condition of a fluid flow passage between a communicating condition and a shutoff condition.

2. Description of the Related Art

According to a conventional lever type switching valve of this type, a piston and a valve opening-closing stem are linked through radially disposed cams, and thrust of the piston is increased in accordance with leverage of the cams (refer to, for example, Japanese Patent No. 3067977).

According to another conventional lever type switching valve, a lever member having a power point, a fulcrum and a working point is disposed within a valve chamber; a valve element is formed on the lever member at the working position; and the valve element comes into contact with and separates from a valve seat (refer to, for example, Japanese Utility Model Application Laid-Open (kokai) No. H01-118270).

### BRIEF DESCRIPTION OF THE INVENTION

According to the lever type switching valve described in Japanese Patent No. 3067977, in order to drive the radially disposed cams by a single piston, all of the cams are disposed within the diameter of the piston. Accordingly, the diameter of the piston cannot be reduced; as a result, an increase in the size of the switching valve is unavoidable.

According to the lever type switching valve described in Japanese Utility Model Application Laid-Open (kokai) No. H01-118270, only a single lever member is swung by a plunger; therefore, there is no need to increase the diameter of the plunger for driving a plurality of lever members. However, in the lever type switching valve described in Japanese Utility Model Application Laid-Open (kokai) No. H01-118270, since a valve element is formed on a swinging lever member, the valve element may fail to appropriately come into contact with the corresponding valve seat due to inclined contact of the valve element with the valve seat.

The present invention has been conceived in view of the above circumstances, and a main object of the invention is to provide a lever type switching valve whose thickness can be reduced and in which a valve element can appropriately come into contact with a valve seat section.

In order to solve the above problem, the present invention has employed the following implementation.

First implementation is characterized by comprising: (a) a body having a flow passage of fluid, a valve seat section, an operation chamber, a swing chamber and a drive chamber inside the body, the operation chamber facing the valve seat section and extending rectilinearly, the swing chamber extending to intersect with the operation chamber at an end of the operation chamber located opposite the valve seat section, the drive chamber extending rectilinearly to intersect with the swing chamber at a position offset from an extension of the operation chamber, and the operation chamber, the swing chamber and the drive chamber extending along a reference plane; (b) a valve rod inserted into the operation chamber and adapted to reciprocate in an extending direction of the operation chamber to come into contact with and separate from the valve seat section; (c) a piston rod inserted into the drive chamber and adapted to reciprocate in an extending direction of the drive chamber; and (d) a lever member accommodated within the swing chamber and having a fulcrum member, wherein (i) the lever member is configured that a distance between the fulcrum member and a second contact position where the piston rod and the lever member come into contact with each other is longer than a distance between the fulcrum member and a first contact position where the valve rod and the lever member come into contact with each other, and (ii) reciprocation of the piston rod swings the lever member about the fulcrum member, and swinging of the lever member reciprocates the valve rod.

According to the above configuration, the body has the operation chamber facing the valve seat section and extending rectilinearly, the swinging chamber extending to intersect with the operation chamber at an end of the operation chamber located opposite the valve seat section and the drive chamber extending to intersect with the swinging chamber at a position offset from an extension of the operation chamber. The valve rod and the piston rod are respectively inserted into the operation chamber and the drive chamber, and the lever member is accommodated in the swinging chamber. Since the operation chamber, the swinging chamber and the drive chamber extend along the reference plane, the length of the body in a direction perpendicular to the reference plane can be short, whereby the switching valve can be thin.

The piston rod inserted into the drive chamber reciprocates in the extending direction of the drive chamber. The reciprocation of the piston rod swings the lever member inserted into the swinging chamber about the fulcrum member. As a result, the swinging of the lever member reciprocates the valve rod inserted into the operation chamber in the extending direction of the operation chamber. Thus, since the valve rod reciprocates in the extending direction of the operation chamber to come into contact with and separate from the valve seat section, as compared with the case where the valve element swings, the valve rod and the valve seat section can appropriately come into contact with each other.

Furthermore, the distance between the fulcrum member and the second contact position where the piston rod and the lever member come into contact with each other is longer than the distance between the fulcrum member and the first contact position where the valve rod and the lever member come into contact with each other. Thus, the lever member can amplify a drive force of the piston rod to reciprocate the valve rod. Therefore, a drive force which the piston rod applies to the lever member can be reduced, whereby the piston rod can be reduced in size.

Second implementation is characterized in that (i) the drive chamber is provided at a position located on a side opposite the operation chamber with respect to the swinging chamber and offset from the extension of the operation chamber; (ii) the fulcrum member is provided in the lever member between the first contact position and the second contact position; (iii) the body has a first auxiliary chamber provided on a side opposite the operation chamber with respect to the swinging chamber; and (iv) a first urging implementation for urging the lever member toward the valve rod is provided within the first auxiliary chamber.

According to the above configuration, in the body, the first auxiliary chamber is provided on a side opposite the operation chamber with respect to the swinging chamber, and the first urging mechanism is provided within the first auxiliary chamber. Since the first urging mechanism urges the lever member toward the valve rod, an urging force of the first urging mechanism brings the valve rod into contact with the valve seat section. Thus, a normally closed switching valve can be implemented.

Third implementation is characterized in that (i) the drive chamber is provided at a position located on a side opposite the operation chamber with respect to the swinging chamber and offset from an extension of the operation chamber; (ii) the fulcrum member is provided in the lever member between the first contact position and the second contact position; (iii) the body has a second auxiliary chamber provided on a side opposite the drive chamber with respect to the swinging chamber; and (iv) a second urging mechanism for urging the lever member toward the piston rod is provided within the second auxiliary chamber.

According to the above configuration, the second auxiliary chamber is provided on a side opposite the drive chamber with respect to the swinging chamber, and the second urging mechanism is provided within the second auxiliary chamber. Furthermore, the second urging mechanism urges the lever member toward the piston rod. The fulcrum member is provided in the lever member between the first contact position and the second contact position. Thus, when the second urging mechanism urges the power point toward the piston rod, the working point of the lever member is urged toward the valve rod. Accordingly, an urging force of the second urging mechanism brings the valve rod into contact with the valve seat section. Thus, a normally closed switching valve can be implemented.

Meanwhile, as mentioned above, the distance between the fulcrum member and the second contact position is longer than the distance between the fulcrum member and the first contact position. Thus, since an urging force of the second urging mechanism is amplified through the lever member and is then applied to the valve rod, the valve rod and the valve seat section can be reliably brought into contact with each other. In other words, even though an urging force of the second urging mechanism is small, a sufficient urging force can be applied to the valve rod through the lever member; therefore, a small-sized second urging mechanism can be employed.

Furthermore, in the case of employment of the configuration of the second implementation, an urging force of the first urging mechanism and an urging force of the second urging mechanism collectively bring the valve rod into contact with the valve seat section. Thus, in a normally closed switching valve, the valve rod and the valve seat section can be more reliably brought into contact with each other. Furthermore, an urging force for bringing the valve rod into contact with the valve seat section can be divided into that of the first urging mechanism and that of the second urging mechanism, whereby the first and second urging mechanisms can be reduced in size.

Fourth implementation is characterized in that (i) a third urging mechanism for urging the valve rod toward the lever member is provided within the operation chamber; (ii) the lever member is configured to allow changeover of position of the fulcrum member to a position located opposite the second contact position with respect to the first contact position; (iii) the body has a second auxiliary chamber provided on a side opposite the drive chamber with respect to the swinging chamber; (iv) a second urging mechanism for urging the lever member toward the piston rod is provided within the second auxiliary chamber; and (v) the first urging mechanism is configured to be detachable.

According to the above configuration, the third urging mechanism urges the valve rod toward the lever member to separate the valve rod from the valve seat section. In the lever member, by means of changeover of the position of the fulcrum member to a position located opposite the second contact position with respect to the first contact position, the power point and the working point of the lever member are swung in the same direction. Also, through detachment of the first urging mechanism, there can be eliminated an urging force of the first urging mechanism which brings the valve rod into contact with the valve seat section.

As a result of the second urging mechanism urging the lever member toward the piston rod, an urging force of the third urging mechanism holds the valve rod in a condition of separation from the valve seat section. When the piston rod is moved toward the piston rod, the lever member moves the valve rod toward the valve seat section. Thus, while many component members are used in common, the normally closed switching valve according to the second implementation can be changed to a normally open switching valve. Furthermore, in the normally closed switching valve and the normally open switching valve, by means of the same piston rod being driven in the same direction, the valves can respectively be opened and closed.

Fifth implementation is characterized in that (i) the drive chamber is provided at a position located on a side opposite the operation chamber with respect to the swing chamber and offset from an extension of the operation chamber; (ii) a third urging mechanism for urging the valve rod toward the lever member is provided within the operation chamber; and (iii) the fulcrum member is provided in the lever member on a side opposite the second contact position with respect to the first contact position.

According to the above configuration, since the third urging mechanism urges the valve rod toward the lever member, the valve rod is separated from the valve seat section. In the lever member, since the fulcrum member is provided on a side opposite the second contact position with respect to the first contact position, the power point and the working point of the lever member are swung in the same direction. Thus, when the piston rod is moved toward the lever member, the lever member moves the valve rod toward the valve seat section. That is, a normally open switching valve can be implemented. Thus, the normally open switching lever can be thin and can establish appropriate contact between the valve rod and the valve seat section.

Sixth implementation is characterized in that the lever member has a contact member of which at least a portion in contact with the valve rod has an arcuate cross section and is in point or line contact with the valve rod.

According to the above configuration, the lever member has the contact member which is in point or line contact with the valve rod. Thus, friction generated on the lever member and the valve rod can be reduced, whereby there can be restrained wear-induced deterioration and generation of fine particles.

Seventh implementation is characterized in that the valve rod has a first flat portion perpendicular to a reciprocating direction of the valve rod and in contact with the contact member.

According to the above configuration, the valve rod has the first flat portion perpendicular to the reciprocating direction of the valve rod. Thus, even when the angle between the lever member and the valve rod varies as a result of swinging of the lever member, force which is applied from the contact member to the valve rod through the first flat portion is applied always in the reciprocating direction of the valve rod. As a result, in the course of reciprocation of the valve rod, there can be restrained generation of force which is applied in such a direction as to incline the valve rod, whereby the valve rod and the valve seat section can be stably in contact with each other.

Eighth implementation is characterized in that the lever member has a contact member of which at least a portion in contact with the piston rod has an arcuate cross section and is in point or line contact with the piston rod.

According to the above configuration, the lever member has the contact member which is in point or line contact with the piston rod. Thus, friction generated on the lever member and the piston rod can be reduced, whereby there can be restrained wear-induced deterioration and generation of fine particles.

Ninth implementation is characterized in that the piston rod has a second flat portion perpendicular to the reciprocating direction of the piston rod and in contact with the contact member.

According to the above configuration, the piston rod has the second flat portion perpendicular to the reciprocating direction of the piston rod. Thus, even though the angle between the lever member and the piston rod varies as a result of swinging of the lever member, force which is applied from the contact member to the piston rod through the second flat portion is applied always in the reciprocating direction of the piston rod. As a result, in the course of reciprocation of the piston rod, there can be restrained generation of force which is applied in such a direction as to incline the piston rod, whereby a drive force of the piston rod can be stably transmitted to the lever member.

Tenth implementation is characterized in that the contact member is a sphere provided rotatably in the lever member.

In the course of swinging of the lever member, the contact member moves while following an arcuate locus. By contrast, the valve rod and the piston rod move in respective straight lines; accordingly, the relative position between the contact member and the valve rod and the relative position between the contact member and the piston rod vary with swinging of the lever member. Thus, in the tenth implementation, the sphere serving as the contact member is rotatably provided in the lever member such that the sphere rotates with variation of the relative position between the lever member and the valve rod or the piston rod in the course of swinging of the lever member. By virtue of this, friction generated between the sphere and the valve rod or the piston rod can be effectively reduced.

Eleventh implementation is characterized in that the contact member is a columnar member which is provided in the lever member to be rotatable about an axis in parallel with an axis of the fulcrum member and whose opposite end portions have respective arcuate cross sections.

In the eleventh implementation, the columnar member serving as the contact member is provided in the lever member in a rotatable manner such that the columnar member rotates with variation of the relative position between the lever member and the valve rod or the piston rod in the course of swinging of the lever member. By virtue of this, friction generated between the columnar member and the valve rod or the piston rod can be effectively reduced.

Twelfth implementation is characterized by further comprising: (e) a slide which is provided within the drive chamber and is slid toward the lever member by a drive force; (f) a stopper which comes into contact the slide slid by the drive force to stop the slide; and (g) an urging member which is elastically deformable in an extending direction of the piston rod and connects the slide and the piston rod, wherein in a condition in which the slide is stopped by the stopper, an elastic force of the urging member urges the piston rod toward the lever member.

In the above configuration, in a condition in which the slide is stopped by the stopper, an elastic force of the urging member is applied to the piston rod. That is, a drive force of sliding the slide is received by the stopper, and only an elastic force of the urging member is applied to the piston rod. Therefore, direct application of a large drive force to the piston rod is prevented, whereby breakage of inner mechanisms of the body, particularly the valve seat section and the valve rod, can be restrained.

As mentioned above, a drive force of the piston rod is amplified by the lever member and is then applied to the valve rod. Accordingly, if a large force is applied to the piston rod, a very large drive force is applied to the valve rod. Thus, as in the case of the present implementation, through employment of configuration to apply only an elastic force of the urging member to the piston rod, there can be reliably prevented a situation in which the valve rod is strongly pressed against the valve seat section.

Thirteenth implementation is characterized in that the body has a position sensor configured to detect or estimate the position of the valve rod.

According to the above configuration, the position of the valve rod is detected or estimated by means of the position sensor, whereby valve opening can be detected.

### BRIEF DESCRIPTION OF THE DRAWINGS

FIG. 1 is a cross-sectional view showing a lever type switching valve according to a first embodiment.

FIG. 2 is a cross-sectional view taken along line II-II of FIG. 1.

FIG. 3 is a cross-sectional view showing a configuration of tightening a bolt.

FIG. 4 is a cross-sectional view showing actions of the lever type switching valve of FIG. 1.

FIG. 5 is a cross-sectional view showing a modified lever type switching valve.

FIG. 6 is a cross-sectional view showing a lever type switching valve according to a second embodiment.

FIG. 7 is a cross-sectional view showing actions of the lever type switching valve of FIG. 6.

FIG. 8 is a cross-sectional view showing a lever type switching valve according to a third embodiment.

FIG. 9 is a cross-sectional view showing, on an enlarged scale, essential portions of the lever type switching valve of the third embodiment.

FIG. 10 is a cross-sectional view showing a modified lever type switching valve of the third embodiment.

FIG. 11 is a cross-sectional view showing a lever type switching valve according to a fourth embodiment.

FIG. 12 is a cross-sectional view showing actions of the lever type switching valve of the fourth embodiment.

FIG. 13 is a cross-sectional view showing a lever type switching valve according to a fifth embodiment.

FIG. 14 is a cross-sectional view showing a lever type switching valve implemented as a three-way valve.

### DETAILED DESCRIPTION OF EMBODIMENTS OF THE INVENTION

### First Embodiment

A first embodiment will next be described with reference to the drawings. The present embodiment is of a lever type switching valve used in a semiconductor manufacturing apparatus or the like and adapted to switch over the condition of a process gas flow passage between a communicating condition and a shutoff condition. The lever type switching valve of the present embodiment is a normally closed switching valve.

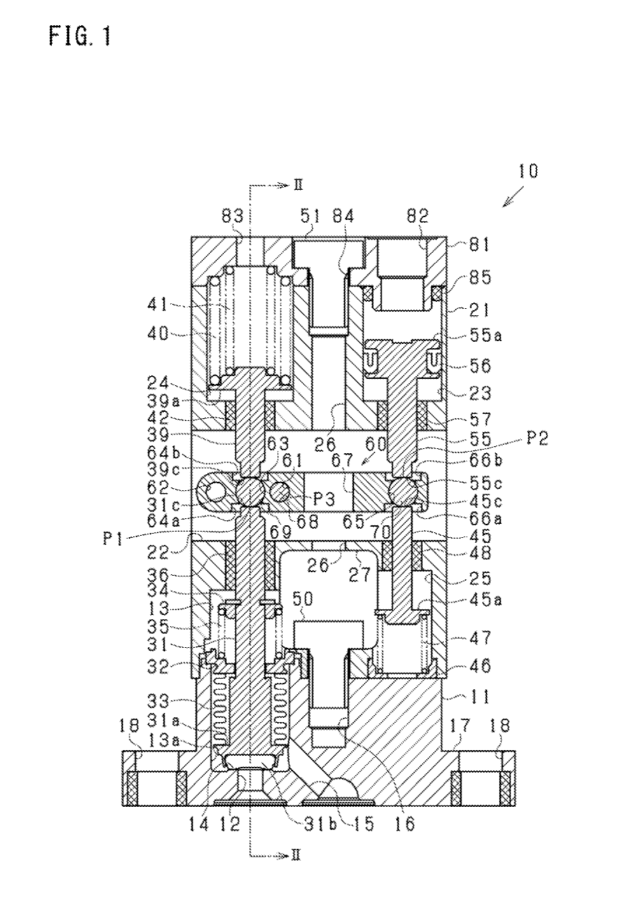

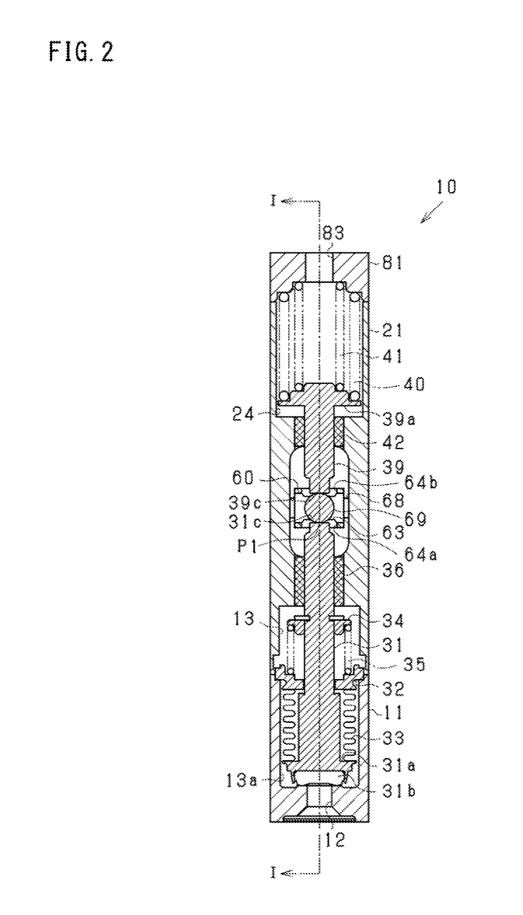

FIG. 1 is a sectional view showing a lever type switching valve 10 of the present embodiment, and FIG. 2 is a sectional view taken along line II-II of FIG. 1. FIG. 1 corresponds to a sectional view taken along line I-I of FIG. 2. As shown in FIGS. 1 and 2, the lever type switching valve 10 includes a flow passage block 11, a case 21, a valve rod 31, a first urging rod 39, a second urging rod 45, a piston rod 55, a lever member 60 and a cover 81. In the lever type switching valve 10, the piston rod 55 is reciprocated to swing the lever member 60. The swinging of the lever member 60 reciprocates the valve rod 31 to open and close the valve.

The flow passage block 11 is formed into a thin rectangular-parallelepiped shape from, for example, stainless steel having chemical resistance. In the flow passage block 11, depth (horizontal length in FIG. 2) is smaller as compared with width (horizontal length in FIG. 1) and height (vertical length in FIGS. 1 and 2). One side in the height direction (lower side in FIGS. 1 and 2) is referred to as the lower side, and the other side in the height direction (upper side in FIGS. 1 and 2) is referred to as the upper side.

The flow passage block 11 has an inlet flow passage 12 (channel) into which process gas flows, a valve chamber 13a into which the valve rod 31 is inserted, and an outlet flow passage 15 (channel) from which process gas flows out. The inlet flow passage 12 and the outlet flow passage 15 open at the lower surface (mounting surface) of the flow passage block 11. The inlet flow passage 12 and the outlet flow passage 15 communicate with each other through the valve chamber 13a. The valve chamber 13a is formed into a circular columnar shape and extends rectilinearly in the height direction of the flow passage block 11. The valve chamber 13a opens at the upper surface of the flow passage block 11. The valve chamber 13a extends along substantially the entire depth of the flow passage block 11. An annular valve seat section 14 is formed at a connection between the inlet flow passage 12 and the valve chamber 13a.

The flow passage block 11 has a bolt hole 16 formed therein for threading engagement with a bolt 50 (fastening member). The bolt hole 16 extends downward from the upper surface of the flow passage block 11. The flow passage block 11 has juts 17. The juts 17 have respective insertion holes 18 into which unillustrated bolts are inserted respectively. The insertion holes 18 extend through the respective juts 17 in the height direction of the flow passage block 11. Through threading engagement of the bolt 50 with the bolt hole 16, the flow passage block 11 and the case 21 are fastened together.

The case 21 is formed into a thin rectangular-parallelepiped shape from, for example, aluminum material or PPS (Poly Phenylene Sulfide) resin. In the case 21, depth (horizontal length in FIG. 2) is smaller as compared with width (horizontal length in FIG. 1) and height (vertical length in FIGS. 1 and 2). The upper surface of the flow passage block 11 and the lower surface of the case 21 have substantially the same dimensions, and the case 21 is mounted on the upper surface of the flow passage block 11. That is, the flow passage block 11 and the case 21 have substantially the same depth and substantially the same width.

An operation chamber 13 is formed in such a manner as to extend from the flow passage block 11 to the case 21. The operation chamber 13 is formed into a circular columnar shape and extends rectilinearly in the height direction of the flow passage block 11 and the case 21. The operation chamber 13 extends along substantially the entire depth of the flow passage block 11. The valve chamber 13a is a lower portion of the operation chamber 13, and the operation chamber 13 faces the valve seat section 14.

The case 21 has a swinging chamber 22 formed at its intermediate portion with respect to the height direction of the case 21 and extending in the width direction of the case 21. The swinging chamber 22 is formed into a rectangular-parallelepiped shape, and the longitudinal direction of the swinging chamber 22 coincides with the width direction of the case 21. The swinging chamber 22 extends through the case 21 in the width direction of the case 21. An upper portion of the operation chamber 13 communicates with a lower portion of the swinging chamber 22. That is, the swinging chamber 22 extends in such a manner as to intersect with the operation chamber 13 at an end of the operation chamber 13 located opposite the valve seat section 14.

The case 21 has a first auxiliary chamber 24 formed on a side opposite the operation chamber 13 with respect to the swinging chamber 22. The first auxiliary chamber 24 is formed into a circular columnar shape and extends rectilinearly in the height direction of the case 21. A lower portion of the first auxiliary chamber 24 communicates with an upper portion of the swinging chamber 22, and an upper portion of the first auxiliary chamber 24 opens at the upper surface of the case 21. The first auxiliary chamber 24 extends along substantially the entire length of the case 21 in the depth direction of the flow passage block 11. The center axis of the operation chamber 13 and the center axis of the first auxiliary chamber 24 coincide with each other.

The case 21 has a drive chamber 23 formed at a position located on a side opposite the operation chamber 13 with respect to the swinging chamber 22 and offset from an extension of the operation chamber 13. The drive chamber 23 is formed into a circular columnar shape and extends rectilinearly in the height direction of the case 21. A lower portion of the drive chamber 23 communicates with an upper portion of the swinging chamber 22, and an upper portion of the drive chamber 23 opens at the upper surface of the case 21. That is, the drive chamber 23 extends in such a manner as to intersect with the swinging chamber 22. The drive chamber 23 is formed along substantially the entire length of the case 21 in the depth direction of the flow passage block 11.

The case 21 has a second auxiliary chamber 25 formed on a side opposite the drive chamber 23 with respect to the swinging chamber 22. The second auxiliary chamber 25 is formed into a circular columnar shape and extends rectilinearly in the height direction of the case 21. An upper portion of the second auxiliary chamber 25 communicates with a lower portion of the swinging chamber 22, and a lower portion of the second auxiliary chamber 25 opens at the lower surface of the case 21. The diameter of the second auxiliary chamber 25 is smaller than that of the first auxiliary chamber 24. The center axis of the drive chamber 23 and the center axis of the second auxiliary chamber 25 coincide with each other.

The case 21 has an attachment hole 26 extending in the height direction of the case 21 and located, with respect to the width direction (an extending direction of the swing chamber 22) of the case 21, between a section composed of the operation chamber 13 and the first auxiliary chamber 24 and a section composed of the second auxiliary chamber 25 and the drive chamber 23. The attachment hole 26 extends across the swing chamber 22 and opens at the upper surface (end surface) of the case 21. The attachment hole 26 has such dimensions as to allow insertion of a tool for tightening the bolt 50.

The case 21 has an insertion hole 27 extending in the depth direction of the case 21 and communicating with the attachment hole 26. The insertion hole 27 extends through the case 21 in the depth direction of the case 21 in a region between the operation chamber 13 and the second auxiliary chamber 25. The insertion hole 27 has such dimensions as to allow insertion of the bolt 50 into the case 21.

The center axes of the operation chamber 13, the swing chamber 22, the drive chamber 23, and the first auxiliary chamber 24 are disposed on an unillustrated imaginary plane (hereinafter, called the reference plane). That is, the operation chamber 13, the swing chamber 22, the drive chamber 23 and the first auxiliary chamber 24 extend along the reference plane. Also, the center axes of the attachment hole 26 and the bolt hole 16 are disposed on the reference plane; i.e., the attachment hole 26 and the bolt hole 16 extend along the reference plane.

The valve rod 31 is inserted into the operation chamber 13. The valve rod 31 is formed into a circular columnar shape from, for example, stainless steel having chemical resistance. The valve rod 31 is disposed in such a manner as to extend in the height direction (vertical direction) of the flow passage block 11 and the case 21. The valve rod 31 has a flange 31a at its lower end portion. A valve seat 31b is attached to a lower portion of the flange 31a. The valve seat 31b is formed into a disk shape from, for example, fluororesin having chemical resistance. The valve seat 31b faces the valve seat section 14. The valve seat 31b has such dimensions as to correspond to the valve seat section 14 and shuts off communication between the inlet flow passage 12 and the valve chamber 13a through contact with the valve seat section 14.

Bellows 33 are attached to an upper portion of the flange 31a and extend in such a manner as to cover a lower portion of the valve rod 31. The bellows 33 are formed into a cylindrical shape from, for example, stainless steel having chemical resistance. An upper portion of the bellows 33 is connected to an annular spring shoe 32. The valve rod 31 extends through the spring shoe 32. The spring shoe 32 is attached to an upper portion of the valve chamber 13a; i.e., to the upper surface of the flow passage block 11. The spring shoe 32, the bellows 33 and the valve rod 31 collectively seal an upper portion of the valve chamber 13a.

An annular spring shoe 34 is attached to the outer circumference of an intermediate portion of the valve rod 31. The spring shoe 34 is disposed within the operation chamber 13 above the spring shoe 32. A compression spring 35 is attached between the spring shoes 32 and 34. The compression spring 35 is in contact with the spring shoes 32 and 34 and urges the valve rod 31 upward (in a direction of separating the valve rod 31 from the valve seat section 14). The compression spring 35 and the spring shoes 32 and 34 constitute a third urging mechanism.

A cylindrical bush 36 (sliding contact member) is attached to an upper portion of the operation chamber 13. The valve rod 31 extends through the bush 36. The bush 36 slidably supports the valve rod 31. Thus, the valve rod 31 can reciprocate in the extending direction of the operation chamber 13. Reciprocation of the valve rod 31 brings the valve seat 31b into contact with and separates the valve seat 31b from the valve seat section 14. A clearance (second clearance) is formed between the bush 36 and the valve rod 31 for allowing some inclination of the valve rod 31 in relation to the bush 36. Thus, even though the contact surfaces of the valve seat section 14 and the valve seats 31b are inclined to some extent in relation to the center axes of the valve seat section 14 and the valve seat 31b as a result of manufacturing errors of the valve seat section 14, the valve rod 31 and the valve seat 31b, and an attachment error of the valve rod 31 and the valve seat 31b, the valve seat 31b comes into contact with the valve seat section 14 while following the profile of the valve seat section 14.

The first urging rod 39 and the piston rod 55 are respectively inserted into the first auxiliary chamber 24 and the drive chamber 23. The first urging rod 39 and the piston rod 55 are formed into circular columnar shapes from, for example, stainless steel having chemical resistance. The first urging rod 39 and the piston rod 55 are disposed in such a manner as to extend in the height direction (vertical direction) of the case 21.

The cover 81 is attached to the upper surface of the case 21. The cover 81 is formed into a thin rectangular-parallelepiped shape from, for example, aluminum material or PPS (Poly Phenylene Sulfide) resin. In the cover 81, depth (horizontal length in FIG. 2) is smaller than width (horizontal length in FIG. 1). The upper surface of the case 21 and the lower surface of the cover 81 have substantially the same dimensions. That is, the case 21 and the cover 81 have substantially the same depth and substantially the same width.

The cover 81 has a port 82 formed therein and communicating with the drive chamber 23. The port 82 extends in the height direction of the cover 81 and opens at the upper surface of the cover 81. The cover 81 has an air vent 83 formed therein and communicating with the first auxiliary chamber 24. The air vent 83 extends in the height direction of the cover 81 and opens at the upper surface of the cover 81. The cover 81 has a through hole 84 formed therein and communicating with the attachment hole 26. The through hole 84 extends in the height direction of the cover 81 and opens at the upper surface of the cover 81. A bolt 51 (fastening member) is inserted through the through hole 84 and fastens the case 21 and the cover 81 together. The flow passage block 11, the case 21 and the cover 81 constitute the body.

The first urging rod 39 has a flange 39a at its upper end portion. Compression springs 40 and 41 are attached between the flange 39a and the lower surface of the cover 81. The compression springs 40 and 41 are in contact with the flange 39a and with the lower surface of the cover 81 and urge the first urging rod 39 downward (toward the valve seat section 14).

A circular columnar piston 55a is provided at an upper end portion of the piston rod 55. A seal member 56 is attached to the outer circumference of the piston 55a. The seal member 56 provides a seal between the inner circumferential surface of the drive chamber 23 and the outer circumferential surface of the piston 55a. The seal member 56 can slide on the inner circumferential surface of the drive chamber 23. Also, a seal member 85 provides a seal at an upper portion of the drive chamber 23 between the case 21 and the cover 81. Working air (high-pressure air) is introduced through the port 82 for driving the piston rod 55. Thus, a drive force is applied to the piston rod 55 to urge the piston rod 55 downward (toward the second urging rod 45).

Cylindrical bushes 42 and 57 (sliding contact members) are respectively attached to a lower portion of the first auxiliary chamber 24 and to a lower portion of the drive chamber 23. The first urging rod 39 and the piston rod 55 respectively extend through the bushes 42 and 57. The bushes 42 and 57 slidably support the first urging rod 39 and the piston rod 55, respectively. Thus, the first urging rod 39 and the piston rod 55 can respectively reciprocate in the extending directions of the first auxiliary chamber 24 and the drive chamber 23. The first urging rod 39, the compression springs 40 and 41 and the bush 42 constitute a first urging mechanism.

The second urging rod 45 is inserted into the second auxiliary chamber 25. The second urging rod 45 is formed into a circular columnar shape from, for example, stainless steel having chemical resistance. The second urging rod 45 is disposed in such a manner as to extend in the height direction (vertical direction) of the case 21.

The second urging rod 45 has a flange 45a at its lower end portion. A spring shoe 46 is attached to a lower portion of the second auxiliary chamber 25 between the flow passage block 11 and the case 21. A compression spring 47 is attached between the flange 45a and the spring shoe 46. The compression spring 47 is in contact with the flange 45a and with the spring shoe 46 and urges the second urging rod 45 upward (toward the piston rod 55).

A cylindrical bush 48 (sliding contact member) is attached to an upper portion of the second auxiliary chamber 25. The second urging rod 45 extends through the bush 48. The bush 48 slidably supports the second urging rod 45. Thus, the second urging rod 45 can reciprocate in the extending direction of the second auxiliary chamber 25. The second urging rod 45, the compression spring 47, the spring shoe 46 and the bush 48 constitute a second urging mechanism.

The valve rod 31, the first urging rod 39, the piston rod 55 and the second urging rod 45 have respective flat portions 31C, 39C, 55C and 45C formed at their ends inserted into the swing chamber 22. The flat portions 31C, 39C, 55C and 45C are respectively formed perpendicular to the center axes of the valve rod 31, the first urging rod 39, the piston rod 55 and the second urging rod 45. The flat portions 31C, 39C, 55C and 45C are respectively disposed perpendicular to the reciprocating directions of the valve rod 31, the first urging rod 39, the piston rod 55 and the second urging rod 45. The flat portion 31C of the valve rod 31 corresponds to the first flat portion in the present invention, and the flat portion 55C of the piston rod 55 corresponds to the second flat portion in the present invention.

The lever member 60 is inserted in the swing chamber 22. The lever member 60 is formed into a rectangular columnar shape from, for example, stainless steel having chemical resistance. The lever member 60 is disposed in such a manner as to extend in the width direction of the case 21. The lever member 60 has circular columnar fulcrum holes 61 and 62 formed therein and located away from each other in the longitudinal direction of the lever member 60. The fulcrum holes 61 and 62 are formed in parallel with each other and extend through the lever member 60 in the depth direction. The fulcrum holes 61 and 62 are formed at positions located toward one end (left end in FIG. 1) of the lever member 60 with respect to the extending direction of the lever member 60 (width direction).

The lever member 60 has a circular columnar first hole 63 and a circular columnar second hole 65 formed therein. The first hole 63 and the second hole 65 are formed in parallel with each other and extend through the lever member 60 in the depth direction. The fulcrum holes 61 and 62, and the first and second holes 63 and 65 are in parallel with one another. The first hole 63 is formed at a position located between the fulcrum hole 61 and the fulcrum hole 62. The second hole 65 is formed at a position located toward an end of the lever member 60 opposite the fulcrum holes 61 and 62 and the first hole 63 (toward a right end in FIG. 1) with respect to the extending direction of the lever member 60. Accordingly, the distance between the fulcrum hole 61 and the second hole 65 is longer than the distance between the fulcrum hole 61 and the first hole 63. Also, the distance between the fulcrum hole 62 and the second hole 65 is longer than the distance between the fulcrum hole 62 and the first hole 63.

The lever member 60 has engagement holes 64a and 66a respectively formed in its lower surface and communicating with the first hole 63 and the second hole 65. The lever member 60 has engagement holes 64b and 66b respectively formed in its upper surface and communicating with the first hole 63 and the second hole 65. The center axes of the engagement holes 64a and 64b coincide with each other and perpendicularly intersect with the center axis of the first hole 63. The center axes of the engagement holes 66a and 66b coincide with each other and perpendicularly intersect with the center axis of the second hole 65.

Steel balls 69 and 70 (contact members, spheres) are respectively press-fitted into the first hole 63 and the second hole 65. The steel balls 69 and 70 are formed spherical from, for example, stainless steel having chemical resistance. The steel balls 69 and 70 are respectively press-fitted into the first hole 63 and the second hole 65 from the depth direction (the extending direction of the first and second holes 63 and 65 (horizontal direction in FIG. 2)). In such a press-fitting operation, when the steel ball 69 is press-fitted up to a position where the first hole 63 communicates with the engagement holes 64a and 64b, parts of the steel ball 69 respectively protrude from the engagement holes 64a and 64b. By virtue of engagement of parts of the steel ball 69 with the engagement holes 64a and 64b, the steel ball 69 can be readily positioned in relation to the lever member 60. Similarly, by virtue of engagement of parts of the steel ball 70 with the engagement holes 66a and 66b, the steel ball 70 can be readily positioned in relation to the lever member 60. Particularly, since the depth of the switching valve 10 is about 10 mm, the dimensions of the lever member 60 are far smaller; therefore, such configuration is effective.

The sizes of openings of the first and second holes 63 and 65 are determined so as to form slight clearances (gaps) between the steel ball 69 and the inner circumferential surface of the first hole 63 and between the steel ball 70 and the inner circumferential surface of the second hole 65. Thus, the steel balls 69 and 70 respectively fitted into the first and second holes 63 and 65 are rotatable.

The lever member 60 has a through hole 67 formed near its center with respect to the extending direction of the lever member 60 and extending therethrough in the height direction. The through hole 67 has such a size as to allow insertion of a tool for tightening the bolt 50.

A support shaft 68 is inserted into the fulcrum hole 61 in the depth direction (horizontal direction in FIG. 2). The support shaft 68 (fulcrum member) is formed into a circular columnar shape from, for example, stainless steel having chemical resistance. Opposite end portions of the support shaft 68 are supported by the case 21. The inner circumferential surface of the fulcrum hole 61 and the outer circumferential surface of the support shaft 68 are slidable on each other. Thus, the lever member 60 can swing around the support shaft 68. The outer circumferential surface of the support shaft 68 may be slidable on portions of the case 21 which support the support shaft 68.

The lever member 60 is disposed between the valve rod 31 and the first urging rod 39, and between the piston rod 55 and the second urging rod 45. More specifically, the center axes of the valve rod 31 and the first urging rod 39 pass through the center of the steel ball 69, and the center axes of the piston rod 55 and the second urging rod 45 pass through the center of the steel ball 70. In this condition, the through hole 67 of the lever member 60 faces the attachment hole 26 of the case 21.

The valve rod 31 is urged upward by the compression spring 35 in the operation chamber 13 and is in contact with the lever member 60. The first urging rod 39 is urged downward by the compression springs 40 and 41 in the first auxiliary chamber 24 and is in contact with the lever member 60. When working air is introduced through the port 82, the piston rod 55 is urged downward and comes into contact with the lever member 60. The second urging rod 45 is urged upward by the compression spring 47 in the second auxiliary chamber 25 and is in contact with the lever member 60.

The distance between a center P3 of the support shaft 68 and a second contact position P2 where the piston rod 55 and the lever member 60 are in contact with each other is longer than the distance between the center P3 of the support shaft 68 and a first contact position P1 where the valve rod 31 and the lever member 60 are in contact with each other. Specifically, the steel ball 69 and the flat portion 31C of the valve rod 31 are in contact with each other at the first contact position P1. The steel ball 70 and the flat portion 55C of the piston rod 55 are in contact with each other at the second contact position P2. The support shaft 68 is provided in the lever member 60 between the first contact position P1 and the second contact position P2.

As mentioned above, the steel balls 69 and 70 are formed into spherical shapes and are respectively in point contact with the flat portion 31C of the valve rod 31 and the flat portion 55c of the piston rod 55.

A force with which the compression springs 40 and 41 urge the first urging rod 39 toward the lever member 60 is larger than a force with which the compression spring 35 urges the valve rod 31 toward the lever member 60. Thus, in a condition in which working air is not introduced through the port 82, the valve seat 31b of the valve rod 31 is brought into contact with the valve seat section 14. Furthermore, the compression spring 47 urges the second urging rod 45 toward the lever member 60, whereby the valve rod 31 is urged toward the valve seat section 14 through the lever member 60. At this time, since a force with which the compression spring 47 urges the lever member 60 is amplified by the lever member 60, the employed compression spring 47 is smaller in urging force than the compression springs 40 and 41.

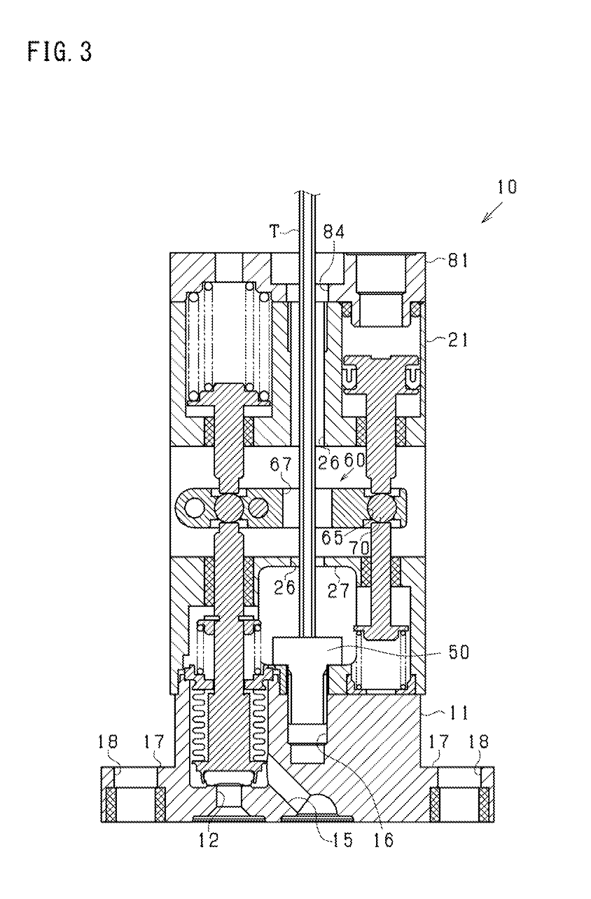

FIG. 3 is a sectional view showing how the bolt 50 is tightened. As shown in FIG. 3, the bolt 50 is inserted into the case 21 through the insertion hole 27. The bolt 50 is disposed at a position which faces the attachment hole 26 and is aligned with the bolt hole 16. When the bolt 50 is to be tightened into the bolt hole 16 of the flow passage block 11, as shown in FIG. 3, a hexagonal wrench T (tool) is inserted into the case 21 through the through hole 84 of the cover 81, the attachment hole 26 of the case 21, the through hole 67 of the lever member 60 and the insertion hole 27 of the case 21. Subsequently, the bolt 50 is tightened by the hexagonal wrench T, thereby fastening the flow passage block 11 and the case 21 together. The switching valve 10 is mounted to, for example, another flow passage block by inserting bolts into the respective insertion holes 18 of the juts 17 and then tightening the bolts. An upstream flow passage of process gas is connected to the inlet flow passage 12, and a downstream flow passage of process gas is connected to the outlet flow passage 15. Instead of attaching the flow passage block 11 to another flow passage block, the flow passage block 11 and another flow passage block 11 may be formed integrally.

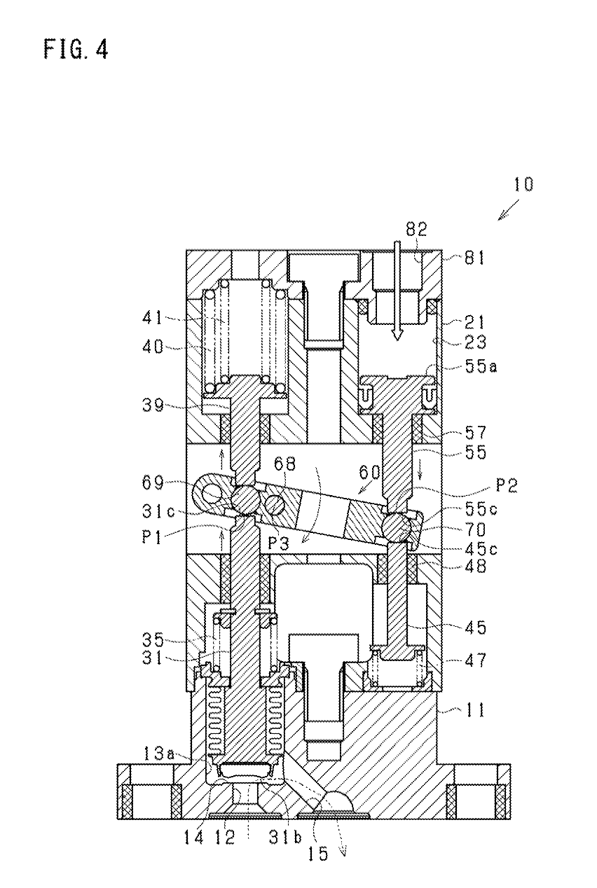

Next, with reference to FIG. 4, actions of the lever type switching valve 10 will be described.

When working air is introduced into the drive chamber 23 through the port 82, pressure (drive force) of the working air moves the piston rod 55 downward. At this time, the piston rod 55 is guided by the bush 57, whereby inclination of the piston rod 55 in relation to the bush 57 is restrained.

When the piston rod 55 is moved downward, the piston rod 55 presses the lever member 60 toward the second urging rod 45, and the lever member 60 moves pivotally in one direction (clockwise in FIG. 4). Meanwhile, at the second contact position P2, the flat portion 55C perpendicular to the reciprocating direction of the piston rod 55 and the steel ball 70 provided in the lever member 60 are in point contact with each other. Thus, a drive force of the piston rod 55 in the reciprocating direction (downward direction in FIG. 4) is smoothly applied to the lever member 60, regardless of the angle between the lever member 60 and the piston rod 55. As a result, load in a direction intersecting with the reciprocating direction (reaction force from the lever member 60) is unlikely to be imposed on the piston rod 55, whereby inclination of the piston rod 55 in relation to the reciprocating direction is restrained. That is, a drive force of the piston rod 55 is stably transmitted to the lever member 60, whereby the two members 55 and 60 can be smoothly operated.

Incidentally, the piston rod 55 moves rectilinearly, whereas the lever member 60 moves pivotally; accordingly, the relative position between the steel ball 70 and the second flat portion 55C of the piston rod 55 varies with the angle of the lever member 60. Specifically, the second contact position P2 slightly shifts in the width direction (horizontal direction in FIG. 4) with swinging of the lever member 60.

Incidentally, the steel ball 70 is rotatably provided in the lever member 60 such that the steel ball 70 can rotate with swinging of the lever member 60. This allows shifting of the second contact position P2, whereby friction generated on the steel ball 70 and the piston rod 55 can be restrained.

Similarly, the flat portion 45C perpendicular to the reciprocating direction of the second urging rod 45 and the steel ball 70 provided in the lever member 60 are in point contact with each other. Thus, the lever member 60 applies the drive force to the second urging rod 45 along the reciprocating direction, regardless of the angle between the lever member 60 and the second urging rod 45. As a result, in the course of reciprocation of the second urging rod 45, the generation of force of inclining the second urging rod 45 is restrained. Also, similar to the case of the piston rod 55, the steel ball 70 rotates with swinging of the lever member 60, whereby the shifting of the contact position between the steel ball 70 and the flat portion 45C of the second urging rod 45 is allowed. This restrains friction generated on the steel ball 70 and the second urging rod 45.

Thus, the second urging rod 45 is pressed downward against an urging force of the compression spring 47. At this time, the second urging rod 45 is guided by the bush 48, whereby inclination of the second urging rod 45 in relation to the bush 48 is restrained.

When the piston rod 55 presses the lever member 60 toward the second urging rod 45, the lever member 60 pivotally moves about the support shaft 68. The support shaft 68 is provided in the lever member 60 between the first contact position P1 and the second contact position P2. Thus, when the steel ball 70 in contact with the piston rod 55 is moved downward, the steel ball 69 in contact with the valve rod 31 and with the first urging rod 39 is moved upward. Meanwhile, the distance between the second contact position P2 and the center P3 of the support shaft 68 is longer than the distance between the first contact position P1 and the center P3 of the support shaft 68. The ratio between the distances corresponds to a leverage, and the drive force of the piston rod 55 is amplified in accordance with the leverage. Thus, a small-sized piston rod 55 can press the first urging rod 39 upward against urging forces of the compression springs 40 and 41.

Since the steel ball 69 is in point contact with the first urging rod 39, similar to the case of the steel ball 70, the drive force can be smoothly transmitted from the lever member 60 which moves pivotally, to the first urging rod 39 which moves rectilinearly. Therefore, there is restrained imposition of load on the first urging rod 39 in a direction intersecting with the reciprocating direction of the first urging rod 39, whereby the lever member 60 and the first urging rod 39 can be operated stably.

Furthermore, the steel ball 69 is provided rotatably in the lever member 60. Thus, the steel ball 69 rotates with swinging of the lever member 60, whereby the shifting of the contact position between the steel ball 69 and the first urging rod 39 is allowed. This can restrain friction generated on the steel ball 69 and the first urging rod 39.

Since the valve rod 31 is urged upward by the compression spring 35, the valve seat 31b of the valve rod 31 is separated from the valve seat section 14. The piston rod 55 is moved downward until the piston 55a comes into contact with the bush 57 or the inner wall of the case 21. Thus, the steel ball 70 is moved to the lowest point, and the steel ball 69 is moved to the highest point. That is, the lever member 60 is pivotally moved to a greatest extent toward a side away from the valve rod 31.

In a condition in which the switching valve 10 is opened (fully opened), a clearance (first clearance) is formed between the valve rod 31 and the steel ball 69 of the lever member 60. Thus, even though manufacturing errors of the valve seat section 14, the valve rod 31, the lever member 60 and the piston rod 55 are accumulated, a stroke of separating the valve rod 31 from the valve seat section 14 can be appropriately secured. As a result, the inlet flow passage 12 and the valve chamber 13a communicate reliably with each other, whereby a predetermined amount of process gas flows out from the outlet flow passage 15.

Next, in the case where the switching valve 10 is to be closed (fully closed), working air is discharged from the drive chamber 23 through the port 82. As a result, urging forces of the compression springs 40, 41 and 47 pivotally move the lever member 60 in the opposite direction (counterclockwise in FIG. 4), thereby moving the valve rod 31 toward the valve seat section 14. At this time, at the first contact position P1, the flat portion 31C perpendicular to the reciprocating direction of the valve rod 31 and the steel ball 69 of the lever member 60 are in point contact with each other. Therefore, the lever member 60 can apply the drive force to the valve rod 31 along the reciprocating direction, regardless of the angle between the lever member 60 and the valve rod 31. As a result, in the course of reciprocation of the valve rod 31, the generation of force of inclining the valve rod 31 can be restrained, whereby the valve seat 31b and the valve seat section 14 can be stably brought into contact with each other.

Furthermore, the steel ball 69 rotates with swinging of the lever member 60, whereby the shifting of the contact position between the steel ball 69 and the valve rod 31 (i.e., the first contact position P1) in the width direction (horizontal direction in FIG. 4) is allowed. This can favorably restrain friction generated on the steel ball 69 and the flat portion 31C of the valve rod 31.

The present embodiment described in detail above has the following advantages.
The body (the flow passage block 11 and the case 21) of the lever type switching valve 10 has the operation chamber 13 facing the valve seat section 14 and extending rectilinearly, the swing chamber 22 extending in such a manner as to intersect with the operation chamber 13 at an end of the operation chamber 13 located opposite the valve seat section 14, and the drive chamber 23 extending in such a manner as to intersect with the swing chamber 22 at a position located on a side opposite the operation chamber 13 with respect to the swing chamber 22 and offset from an extension of the operation chamber 13. The valve rod 31 and the piston rod 55 are respectively inserted into the operation chamber 13 and the drive chamber 23, and the lever member 60 is accommodated in the swing chamber 22. Since the operation chamber 13, the swing chamber 22 and the drive chamber 23 extend along the reference plane, the length of the body in a direction perpendicular to the reference plane can be short. Thus, the lever type switching valve 10 can be thin.
The piston rod 55 inserted into the drive chamber 23 reciprocates in the extending direction of the drive chamber 23. The reciprocation of the piston rod 55 swings the lever member 60 inserted into the swing chamber 22 about the support shaft 68. As a result, the swinging of the lever member 60 reciprocates the valve rod 31 inserted into the operation chamber 13 in the extending direction of the operation chamber 13. Thus, since the valve rod 31 reciprocates in the extending direction of the operation chamber 13 to come into contact with and separate from the valve seat section 14, as compared with the case where the valve element swings, the valve rod 31 and the valve seat section 14 can appropriately come into contact with each other.
Since the valve rod 31 is brought into contact with the valve seat section 14 by urging forces of the compression springs 40 and 41 of the first urging mechanism and an urging force of the compression spring 47 of the second urging mechanism, in the normally closed switching valve 10, the valve rod 31 and the valve seat section 14 can be more reliably brought into contact with each other. Furthermore, by dividing, between the first urging mechanism and the second urging mechanism, an urging force adapted to bring the valve rod 31 and the valve seat section 14 into contact with each other, the first and second urging mechanisms can be reduced in size.
At the first contact position P1, the flat portion 31C perpendicular to the reciprocating direction of the valve rod 31 and the steel ball 69 provided in the lever member 60 are in point contact with each other. Thus, even though the angle between the lever member 60 and the valve rod 31 varies as a result of swinging of the lever member 60, the lever member 60 can apply the drive force to the valve rod 31 along the reciprocating direction of the valve rod 31. As a result, in the course of reciprocation of the valve rod 31, there can be restrained application of force in such a direction as to incline the valve rod 31, whereby the valve rod 31 and the valve seat section 14 can be reliably in contact with each other.
At the second contact position P2, the flat portion 55C perpendicular to the reciprocating direction of the piston rod 55 and the steel ball 70 provided in the lever member 60 are in contact with each other. Thus, even though the angle between the lever member 60 and the piston rod 55 varies as a result of swinging of the lever member 60, the piston rod 55 can apply the drive force to the lever member 60 along the reciprocating direction of the piston rod 55. As a result, there can be restrained application of force in such a direction as to incline the piston rod 55 with respect to the reciprocating direction, whereby the drive force of the piston rod 55 can be stably transmitted to the lever member 60.
The case 21 has the attachment hole 26 extending across the swing chamber 22 at a position located between the operation chamber 13 and the drive chamber 23 with respect to the extending direction of the swing chamber 22 and opening at the upper surface of the case 21. The insertion hole 27 for allowing insertion of the bolt 50 into the case 21 communicates with the attachment hole 26. Thus, the bolt 50 can be inserted into the case 21 through the insertion hole 27 and can be disposed at a position which faces the attachment hole 26. Meanwhile, the lever member 60 has the through hole 67 formed at a position which faces the attachment hole 26. Therefore, the hexagonal wrench T can be inserted through the attachment hole 26 and the through hole 67 of the lever member 60 and can tighten the bolt 50. As a result, there is no need to extend the bolt 50 up to a position near the surface of the case 21, whereby an increase in the length of the bolt 50 can be restrained.

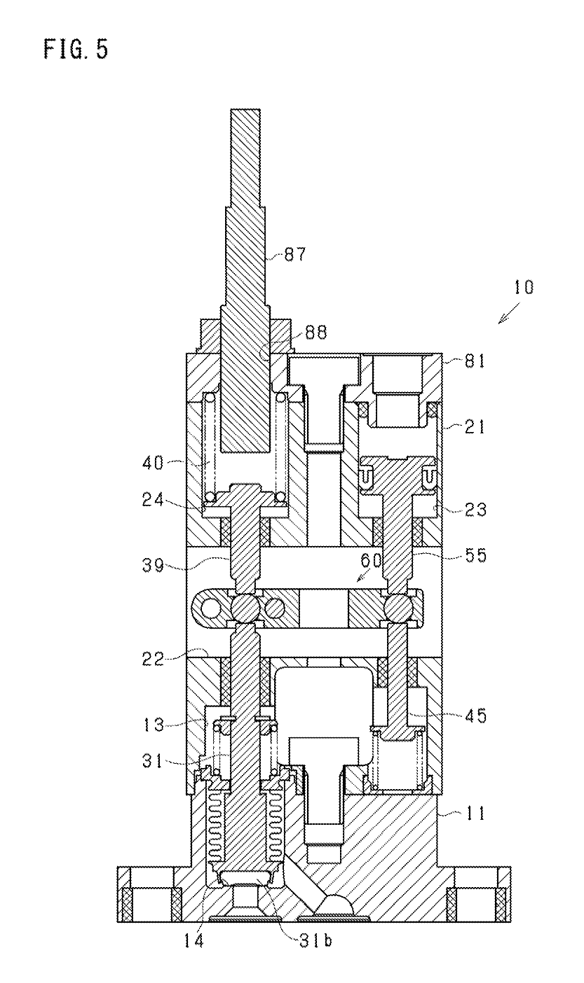

The above embodiment may be modified as follows.
In the above embodiment, the cover 81 has the air vent 83 which communicates with the first auxiliary chamber 24. However, as shown in FIG. 5, the cover 81 may have an insertion hole 88 in place of the air vent 83, for inserting a position sensor 87 into the first auxiliary chamber 24 through the insertion hole 88. Specifically, the insertion hole 88 extends in the height direction and opens at the upper surface of the cover 81. The position sensor 87 may be implemented by, for example, a proximity sensor and has a circular columnar shape. The position sensor 87 is inserted into the first auxiliary chamber 24 through the insertion hole 88 and is attached with a predetermined gap formed between the same and the first urging rod 39. The position sensor 87 detects distance to the first urging rod 39 and, in turn, the position of the first urging rod 39. In the present modification, the compression spring 41 is detached.

According to such a configuration, a first urging mechanism having the first urging rod 39 is provided within the first auxiliary chamber 24. The first urging mechanism reciprocates the first urging rod 39 in the extending direction of the first auxiliary chamber 24, thereby urging the lever member 60 toward the valve rod 31 through the first urging rod 39. The reciprocation of the first urging rod 39 swings the lever member 60, and the swinging of the lever member 60 reciprocates the valve rod 31. Thus, the position of the valve rod 31 varies with the position of the first urging rod 39. Therefore, through detection of the position of the first urging rod 39 by the position sensor 87 inserted into the first auxiliary chamber 24, the position of the valve rod 31 and, in turn, valve opening can be detected. That is, through utilization of the first urging rod 39 which urges the lever member 60 toward the valve rod 31, valve opening can be detected.

Furthermore, the first auxiliary chamber 24 is provided on a side opposite the operation chamber 13 with respect to the swing chamber 22; i.e., on the same side as the drive chamber 23 with respect to the swing chamber 22. Thus, the position sensor 87 and a mechanism for driving the piston rod 55 can be disposed on the same side, whereby spaces required for disposing the mechanism and the sensor can be reduced.

### Second Embodiment

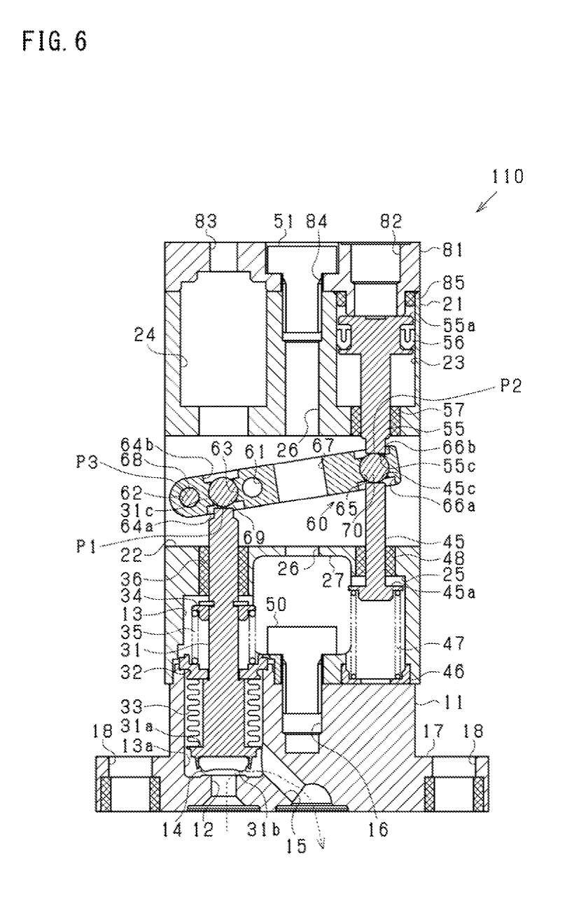

In the first embodiment, the lever type switching valve 10 is configured to be a normally closed switching valve. However, in the second embodiment, a lever type switching valve 110 is configured to be a normally open switching valve. Specifically, as shown in FIG. 6, the switching valve 10 of the first embodiment is modified as follows: the position of the support shaft 68 is changed over to the fulcrum hole 62 located opposite the second contact position P2 with respect to the first contact position P1, and the first urging mechanism (the first urging rod 39, the compression springs 40 and 41 and the bush 42) is detached. Other configurational features are similar to those of the first embodiment. Members corresponding to those of the first embodiment are denoted by the same reference numerals, and description thereof is omitted.

The lever member 60 is configured to allow changeover of position of the support shaft 68 between the fulcrum hole 61 and the fulcrum hole 62. In the second embodiment, the position of the support shaft 68 is changed over to the fulcrum hole 62, and opposite end portions of the support shaft 68 are supported by the case 21. The inner circumferential surface of the fulcrum hole 62 and the outer circumferential surface of the support shaft 68 are slidable on each other. Thus, the lever member 60 can swing about the support shaft 68. The outer circumferential surface of the support shaft 68 may be slidable on portions of the case 21 which support the support shaft 68.

The first urging mechanism (the first urging rod 39, the compression springs 40 and 41 and the bush 42) is configured to be detachable from the case 21 (first auxiliary chamber 24). In the second embodiment, the first urging mechanism is detached from the case 21.

In a condition in which working air is not introduced into the drive chamber 23, the compression spring 35 urges the valve rod 31 upward; accordingly, the valve seat 31b of the valve rod 31 is separated from the valve seat section 14. Also, the compression spring 47 urges the piston rod 55 upward through the lever member 60. Thus, the piston rod 55 is moved upward until its piston portion 55a comes into contact with the inner wall of the cover 81. The steel balls 69 and 70 are moved to the respective highest points, and the lever member 60 is pivotally moved to a greatest extent toward a side away from the valve rod 31.

In a condition in which the lever type switching valve 110 is opened as mentioned above (fully opened), a clearance is formed between the valve rod 31 and the steel ball 69 of the lever member 60. Thus, even though manufacturing errors of the valve seat section 14, the valve rod 31, the lever member 60 and the piston rod 55 are accumulated, a stroke of separating the valve rod 31 from the valve seat section 14 can be appropriately secured. As a result, the inlet flow passage 12 and the valve chamber 13a communicate reliably with each other, whereby a predetermined amount of process gas flows out from the outlet flow passage 15.

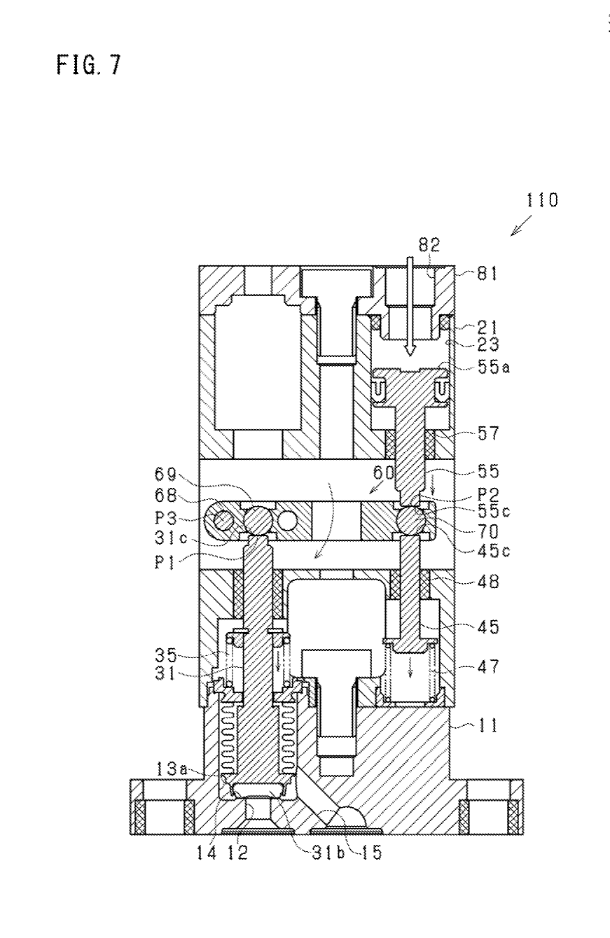

Next, with reference to FIG. 7, actions of the lever type switching valve 110 will be described. The description of actions similar to those of the first embodiment is omitted.

When working air is introduced into the drive chamber 23 through the port 82, pressure (drive force) of the working air moves the piston rod 55 downward. When the piston rod 55 presses the lever member 60 toward the second urging rod 45, the lever member 60 pivotally moves about the support shaft 68. The support shaft 68 is provided in the lever member 60 on a side opposite the second contact position P2 with respect to the first contact position P1. Thus, when the steel ball 70 in contact with the piston rod 55 is moved downward, the steel ball 69 in contact with the valve rod 31 is also moved downward.

The distance between the second contact position P2 and the center P3 of the support shaft 68 is longer than the distance between the first contact position P1 and the center P3 of the support shaft 68. The ratio between the distances corresponds to a leverage, and the drive force of the piston rod 55 is amplified in accordance with the leverage. Thus, a small-sized piston rod 55 can press the second urging rod 45 and the valve rod 31 downward against urging forces of the compression springs 35 and 47.

The valve rod 31 is moved toward the valve seat section 14 through the lever member 60. At this time, at the first contact position P1, the steel ball 69 of the lever member 60 and the flat portion 31C perpendicular to the reciprocating direction of the valve rod 31 are in point contact with each other. Thus, the lever member 60 applies the drive force to the valve rod 31 along the reciprocating direction, regardless of the angle between the lever member 60 and the valve rod 31. As a result, in the course of reciprocation of the valve rod 31, the generation of force of inclining the valve rod 31 can be restrained, whereby the valve seat section 14 and the valve seat 31b of the valve rod 31 can be stably brought into contact with each other.

Also, since the steel ball 69 is rotatably provided in the lever member 60, the steel ball 69 rotates with swinging of the lever member 60. This allows the shifting of the contact position between the steel ball 69 and the flat portion 31C of the valve rod 31 (i.e., the first contact position P1), whereby friction generated between the steel ball 69 and the valve rod 31 can be restrained.

The present embodiment described above in detail has the following advantages. The following description discusses only advantages different from those of the first embodiment.
Since the compression spring 35 of the third urging mechanism urges the valve rod 31 toward the lever member 60, the valve seat 31b of the valve rod 31 is separated from the valve seat section 14. In the lever member 60, by means of changeover of the position of the support shaft 68 to a position located opposite the second contact position P2 with respect to the first contact position P1, the steel ball 70 (power point) and the steel ball 69 (working point) of the lever member 60 are swung in the same direction. Thus, when the compression spring 47 of the second urging mechanism urges the steel ball 70 of the lever member 60 toward the piston rod 55, the steel ball 69 of the lever member 60 is urged in a direction opposite the valve rod 31. Also, through detachment of the first urging mechanism, an urging force of bringing the valve rod 31 into contact with the valve seat section 14 can be eliminated.

When the piston rod 55 is moved toward the lever member 60, the lever member 60 moves the valve rod 31 toward the valve seat section 14. Therefore, while many component members are used in common, the normally closed switching valve 10 of the first embodiment can be changed to the normally open switching valve 110. As a result, in the normally open switching valve 110, a thin structure can be implemented, and the valve seat section 14 and the valve seat 31b of the valve rod 31 can be appropriately brought into contact with each other. Furthermore, in the normally closed switching valve 10 and the normally open switching valve 110, by means of the same piston rod 55 being driven in the same direction, the valves can be opened and closed, respectively.

### Third Embodiment

Next, a lever type switching valve 120 according to a third embodiment will be described. In the third embodiment, similar to the case of the first embodiment, the lever type switching valve 120 is configured to be a normally closed switching valve. Members corresponding to those of the first embodiment are denoted by the same reference numerals, and description thereof is omitted.

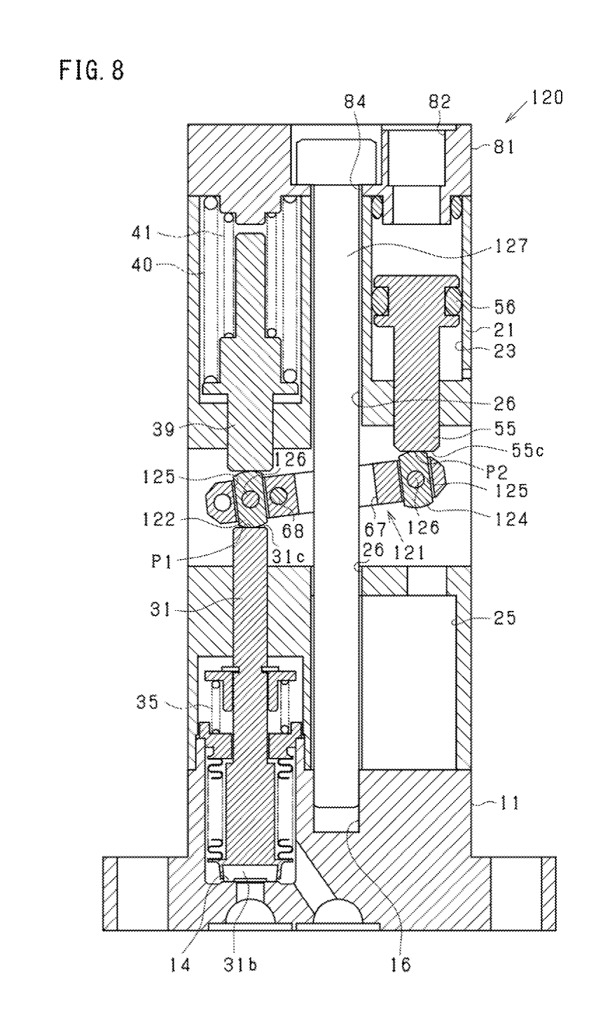

As shown in FIG. 8, the lever type switching valve 120 of the third embodiment differs from that of the first embodiment in that the second urging mechanism is not provided within the second auxiliary chamber 25.

Also, in the first embodiment, the steel balls 69 and 70 are rotatably provided in the lever member 60; however, in the third embodiment, columnar contact members (columnar members 122 and 124) are provided in a rotatable manner in a lever member 121. Opposite end portions of the columnar members 122 and 124 are arcuate in section taken in parallel with the reference plane (arcuate cross section). More specifically, the columnar members 122 and 124 are formed such that opposite end portions of circular columnar bodies have hemispheric shapes. That is, opposite end portions of the columnar members 122 and 124 respectively have spherical surfaces.

The length (height) of the columnar members 122 and 124 is greater than the length (thickness) of the columnar members 122 and 124 in a direction orthogonal to the longitudinal direction of the lever member 121.

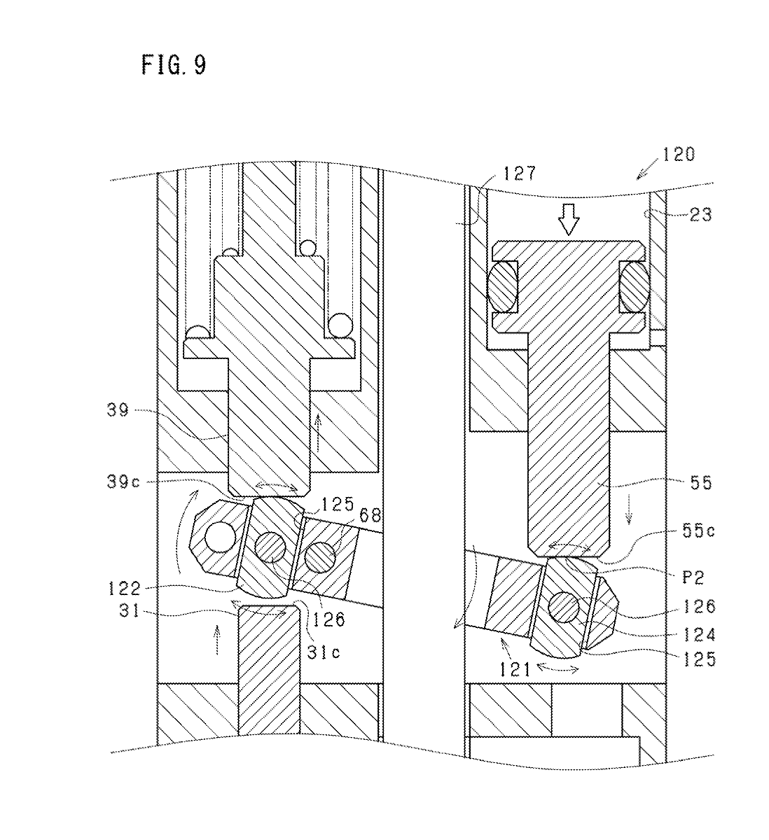

The lever member 121 has a pair of mounting holes 125 formed therein and extending therethrough in a direction orthogonal to the longitudinal direction of the lever member 121. The mounting holes 125 have circular cross sections and are respectively provided in longitudinally opposite end portions of the lever member 121. The columnar members 122 and 124 are inserted into the respective mounting holes 125 and are supported by the lever member 121 through respective axles 126 extending in the same direction as that of the support shaft 68 (depth direction). The sizes of openings (diameters) of the mounting holes 125 are slightly larger than the diameters of the columnar members 122 and 124. That is, as shown in FIG. 9, in a condition in which the columnar members 122 and 124 are inserted into the respective mounting holes 125, slight clearances are formed between the columnar members 122 and 124 and the inner circumferential surfaces of the mounting holes 125, respectively. Accordingly, the columnar members 122 and 124 can respectively swing about the axles 126 within the mounting holes 125.

In a condition in which the columnar members 122 and 124 are inserted into the respective mounting holes 125, opposite end portions of the columnar members 122 and 124 protrude from the mounting holes 125 and are respectively in contact with the valve rod 31, the first urging rod 39 and the piston rod 55. As mentioned above, the end portions of the columnar members 122 and 124 which come into contact with the valve rod 31, the first urging rod 39, and the piston rod 55 have spherical surfaces, respectively. Thus, the columnar member 122 is in point contact with the valve rod 31 and with the first urging rod 39, and the columnar member 124 is in point contact with the piston rod 55.

The third embodiment employs an elongated bolt 127 extending from the position of the bolt 51 to the position of the bolt 50, in place of the bolts 50 and 51 employed in the first embodiment. The elongated bolt 127 extends through the through hole 84 of the cover 81, the attachment hole 26 of the case 21 and the through hole 67 of the lever member 121. The elongated bolt 127 fastens the flow passage block 11, the case 21 and the cover 81 together.

Next, with reference to FIGS. 8 and 9, actions of the lever type switching valve 120 will be described. The description of actions similar to those of the first embodiment is omitted.

As shown in FIG. 8, in a condition in which working air is not supplied to the drive chamber 23, elastic forces of the compression springs 40 and 41 cause the first urging rod 39 to press the lever member 121 (columnar member 122) toward the valve rod 31. Meanwhile, the lever type switching valve 120 of the third embodiment does not have the second urging mechanism in the second auxiliary chamber 25. However, since elastic forces of the two compression springs 40 and 41 securely press the lever member 121 toward the valve rod 31, the valve seat 31b is reliably brought into contact with the valve seat section 14.

When working air is introduced into the drive chamber 23 through the port 82, the flat portion 55C of the piston rod 55 presses the columnar member 124 to pivotally move the lever member 121 in one direction (clockwise in FIG. 9). At this time, since the spherical surface of the columnar member 124 is in point contact with the piston rod 55, friction generated on the columnar member 124 and the piston rod 55 is restrained. Furthermore, force (reaction force) applied from the columnar member 124 to the piston rod 55 through the flat portion 55C is applied in the reciprocating direction of the piston rod 55 (upward direction in FIG. 9). Thus, the piston rod 55 and the lever member 121 can be smoothly operated.

Meanwhile, in the third embodiment also, as a result of swinging of the lever member 121, the second contact position P2 where the piston rod 55 and the columnar member 124 are in contact with each other shifts slightly in the width direction (horizontal direction in FIG. 9). However, the columnar member 124 is supported by the lever member 121 through the axle 126 so as to be rotatable within the mounting hole 125. Thus, as shown in FIG. 9, the columnar member 124 swings slightly with swinging of the lever member 121, thereby allowing shifting of the second contact position P2. Therefore, friction generated on the columnar member 124 and the flat portion 55C of the piston rod 55 can be restrained.

When the piston rod 55 pivotally moves the lever member 121, the columnar member 122 presses the first urging rod 39 upward. In this case also, since the columnar member 122 swings while being in point contact with the flat portion 39C of the first urging rod 39, friction generated on the columnar member 122 and the flat portion 39C is restrained. When the columnar member 122 presses the first urging rod 39 upward, an urging force of the compression spring 35 presses the valve rod 31 upward to separate the valve seat 31b from the valve seat section 14. When the lever member 121 presses the first urging rod 39 upward to a greatest extent, the lever type switching valve 120 is fully opened. At this time, a slight clearance is formed between the valve rod 31 and the columnar member 122 of the lever member 121.

Next, when working air is discharged from the drive chamber 23 through the port 82, urging forces of the compression springs 40 and 41 press the first urging rod 39 downward. As a result, the lever member 121 is pivotally moved in the other direction (counterclockwise in FIG. 8), whereby the columnar member 124 presses the piston rod 55 upward. At the same time, the columnar member 122 presses the valve rod 31 downward against an urging force of the compression spring 35. At this time, the columnar member 122 pivotally moves while being in contact with the flat portion 31C of the valve rod 31, whereby friction generated on the columnar member 122 and the valve rod 31 is restrained. Furthermore, force applied from the columnar member 122 to the valve rod 31 through the flat portion 31C of the valve rod 31 is applied in the reciprocating direction of the valve rod 31 (i.e., downward). Therefore, in spite of variation in the angle between the lever member 121 and the valve rod 31, the valve rod 31 can be pressed straight downward, whereby the lever member 121 and the valve rod 31 can be stably operated.

When the valve seat 31b of the valve rod 31 comes into contact with the valve seat section 14, the first urging rod 39, the lever member 121, and the piston rod 55 stop operating and the lever type switching valve 120 becomes fully closed (see FIG. 8).

The present embodiment described above in detail has the following advantages. The following description discusses only advantages different from those of the first embodiment.
Since the columnar member 122 having a spherical surface is pivotally provided in the lever member 121, the columnar member 122 is in a point contact with the valve rod 31, whereby friction generated on the columnar member 122 and the valve rod 31 can be restrained. Furthermore, the columnar member 122 swings with swinging of the lever member 121, thereby allowing shifting of the first contact position P1 (relative position between the columnar member 122 and the valve rod 31). Thus, friction generated on the columnar member 122 and the valve rod 31 is restrained, whereby there can be restrained wear-induced deterioration of the members 122 and 31 and generation of fine particles.
Similarly, since the columnar member 124 is in point contact with the piston rod 55, friction generated on the columnar member 124 and the piston rod 55 can be restrained. Also, the columnar member 124 swings with swinging of the lever member 121, thereby allowing shifting of the second contact position P2 (relative position between the columnar member 124 and the piston rod 55). Thus, friction generated on the columnar member 124 and the piston rod 55 is restrained, whereby there can be restrained wear-induced deterioration of the members 124 and 55 and generation of fine particles.
The columnar members 122 and 124 can be readily attached to the lever member 121 merely by fitting the axles 126 to the respective columnar members 122 and 124 inserted into the respective mounting holes 125. Therefore, as compared with the case of the steel balls 69 and 70 employed in the first and second embodiments, the columnar members 122 and 124 can be efficiently attached to the lever member 121.
By use of the single elongated bolt 127, the flow passage block 11, the case 21 and the cover 81 are fastened together. Thus, as compared with the case of the first embodiment where the two bolts 50 and 51 are used, the number of components can be reduced, whereby the product cost can be reduced. Furthermore, merely by tightening the single elongated bolt 127, the lever type switching valve 120 can be assembled, so that a working process can be simplified.
The third embodiment is configured as follows: the lever type switching valve 120 is held in a fully closed condition only by urging forces of the compression springs 40 and 41, and the second urging mechanism is not provided in the second auxiliary chamber 25. Thus, as compared with the first embodiment, the number of components can be reduced, whereby the product cost can be reduced.

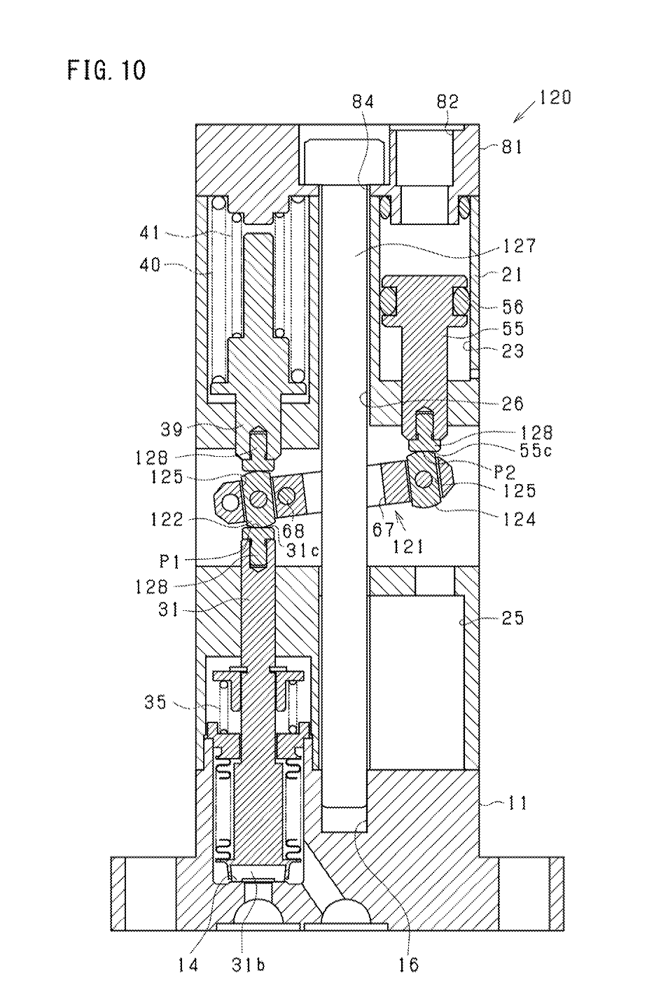

The lever type switching valve 120 of the third embodiment can be modified as follows. As shown in FIG. 10, replaceable flat-end members 128 are provided respectively at end portions of the valve rod 31, the piston rod 55 and the first urging rod 39. The flat-end members 128 have undergone surface treatment for improving wear resistance, such as nitriding. The flat-end members 128 have respective columnar inserts. The inserts of the flat-end members 128 are respectively press-fitted into respective insertion holes provided in the valve rod 31, the piston rod 55 and the first urging rod 39, whereby the flat-end members 128 are attached to the respective rods 31, 55 and 39.

The method of attachment of the flat-end members 128 is not limited to press-fitting. The flat-end members 128 may be threadingly engaged with the valve rod 31 or the like. Specifically, the following configuration may be employed: the flat-end members 128 have respective externally threaded portions, and the externally threaded portions are threadingly engaged with respective internally threaded portions provided in the valve rod 31, the piston rod 55 and the first urging rod 39, respectively.

In this manner, through provision of the surface-treated separate flat-end members 128 in the respective rods 31, 55 and 39, friction generated between the flat-end members 128 and the columnar members 122 and 124 of the lever member 121 can be effectively reduced. This favorably restrains generation of particles resulting from wear of the flat-end members 128 and the columnar members 122 and 124. Surface treatment for improving wear resistance is not limited to a hardening process, such as nitriding. For example, the surfaces of the flat-end members 128 may be smoothed for reducing frictional force against the columnar members 122 and 124.

By virtue of provision of the replaceable flat-end members 128 in the respective rods 31, 55 and 39, only deteriorated flat-end members 128 may be replaced. Therefore, there is no need to replace the entire rods 31, 55 and 39, whereby costs can be curbed.

The replaceable flat-end members 128 can be respectively employed in the lever type switching valves 10 and 110 of the first and second embodiments.

### Fourth Embodiment

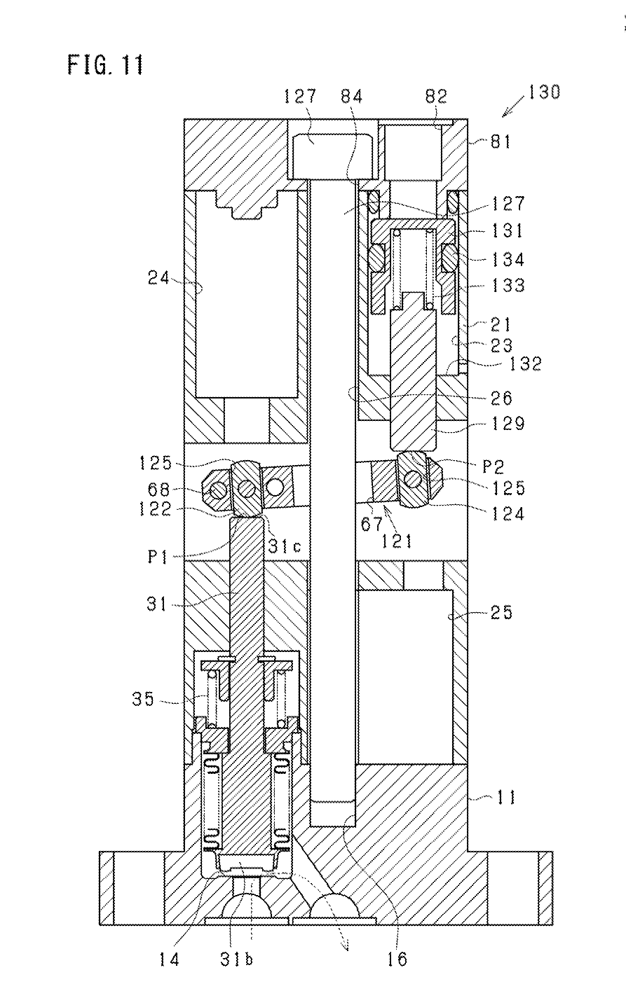

Next, a lever type switching valve 130 according to a fourth embodiment will be described with reference to FIG. 11. In the fourth embodiment, the lever type switching valve 130 is configured to be a normally open switching valve and employs the columnar members 122 and 124 employed in the lever type switching valve 120 of the third embodiment. The following description discusses only configurational features different from those of the first to third embodiments.

The fourth embodiment differs from the first to third embodiments in a mechanism of operating the piston rod 129. A slide 131 is provided, within the drive chamber 23, slidably in the extending direction of the drive chamber 23 (vertical direction in FIG. 11). The slide 131 is a tubular member which opens onto the second auxiliary chamber 25 (downward in FIG. 11) and has an outline slightly smaller than the inner space of the drive chamber 23. The slide 131 has an annular recess formed on its outer circumferential surface, and a seal member 134 is annularly disposed in the recess. The seal member 134 seals the space between the outer circumferential surface of the slide 131 and the inner circumferential surface of the drive chamber 23. When working air is introduced into the drive chamber 23, the pressure of the working air slides the slide 131 toward the lever member 121 (downward in FIG. 11).

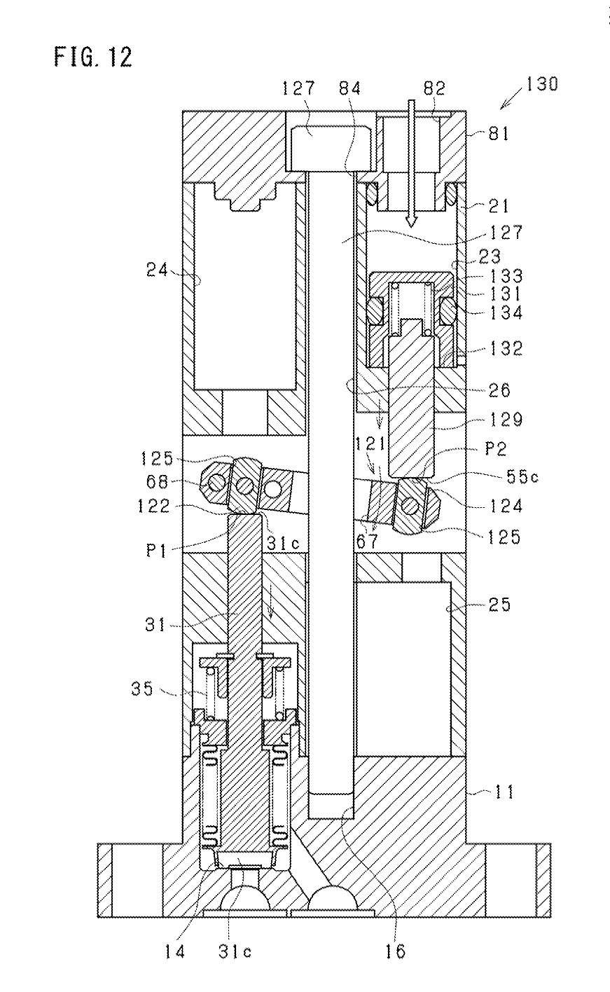

As shown in FIG. 12, when working air slides the slide 131, an opening end portion of the slide 131 comes into contact with an inner end surface (hereinafter called a stopping surface 132) of the drive chamber 23 located toward the lever member 121. That is the stopping surface 132 functions as a stopper to limit the sliding of the slide 131.

A compression spring 133 (urging member) is provided within the slide 131. The compression spring 133 can be elastically deformed in the extending direction of the piston rod 129 (vertical direction in FIG. 11). An elastic force of the compression spring 133 is smaller than pressure (drive force) of working air. An end (upper end in FIG. 11) of the compression spring 133 located opposite the piston rod 129 is connected to the slide 131. An end (lower end in FIG. 11) of the compression spring 133 located toward the piston rod 129 is connected to the piston rod 129. That is, the slide 131 and the piston rod 129 are connected through the compression spring 133.

Thus, when the slide 131 is slid, an elastic force of the compression spring 133 moves the piston rod 129 toward the lever member 121. Then, in a condition in which the stopping surface 132 stops sliding of the slide 131, only an elastic force of the compression spring 133 presses the piston rod 129 toward the lever member 121. That is, a drive force of the working air is not directly applied to the piston rod 129, but an elastic force of the compression spring 133 urges (drives) the piston rod 129.

The fourth embodiment does not have the first urging mechanism and the second urging mechanism. Accordingly, the valve rod 31 is pressed toward the lever member 121 (upward in FIG. 11) only by an urging force of the compression spring 35. That is, the lever type switching valve 130 is held in a fully opened condition only by the urging force of the compression spring 35.

Next, there are described only those actions of the lever type switching valve 130 of the fourth embodiment which differ from those of the first to third embodiments.

When working air is introduced into the drive chamber 23 through the port 82, pressure of working air slides the slide 131 toward the lever member 121. As a result of sliding of the slide 131, an elastic force of the compression spring 133 presses the piston rod 129 toward the lever member 121. Consequently, the flat portion 55c of the piston rod 129 presses the columnar member 124 to pivotally move the lever member 121 about the support member 68. At this time, a force with which the piston rod 129 presses the columnar member 124 is an elastic force of the compression spring 133; i.e., a drive force of the working air is not directly applied to the columnar member 124 (lever member 121).

As a result of the pivotal movement of the lever member 121, the columnar member 122 presses the valve rod 31 to move the valve rod 31 toward the valve seat section 14. A drive force of the piston rod 129 is amplified through the lever member 121 and is then applied to the valve rod 31. Accordingly, if a large force is applied to the piston rod 129, the force is amplified by the lever member 121; consequently, a very large force may possibly be applied to the valve rod 31.

However, the piston rod 129 is operated by an elastic force of the compression spring 133 which is smaller than a drive force of working air. Thus, even though the drive force of the piston rod 129 is amplified by the lever member 121, application of a large force to the valve rod 31 is prevented.

As shown in FIG. 12, when an opening end portion of the slide 131 comes into contact with the stopping surface 132, the slide 131 stops sliding. At this time, only an elastic force of the compression spring 133 is applied to the piston rod 129.

When sliding of the slide 131 is stopped, the valve seat 31b of the valve rod 31 comes into contact with the valve seat section 14, whereby the lever type switching valve 130 becomes fully closed. Even in this case, an elastic force of the compression spring 133 urges the piston rod 129, and a large force is not applied to the valve rod 31; therefore, the valve seat 31b is not strongly pressed against the valve seat section 14. Thus, there can be prevented breakage of the valve rod 31 and the valve seat section 14 resulting from contact-induced impact, and generation of fine particles.

The present embodiment described above in detail has the following advantages. The following description discusses only advantages different from those of the first to third embodiments.
Since elastic force of the compression spring 133 drives the piston rod 129, application of a large force to the valve rod 31 can be restrained. Thus, there can be prevented breakage of the valve seat 31c and the valve seat section 14 caused by impact resulting from the valve seat 31b being strongly pressed against the valve seat section 14.
As a result of contact of an opening end portion of the slide 131 with the stopping surface 132, the slide 131 stops sliding. Thus, the stopping surface 132 can accurately specify the amount of sliding of the slide 131, whereby the amount of movement of the piston rod 129 can be appropriately controlled. As a result, excess movement of the piston rod 129 can be prevented, whereby breakage of the valve seat 31b and the valve seat section 14 can be restrained.

In the lever type switching valve 130 of the fourth embodiment, the valve rod 31 and the piston rod 129 may respectively have the replaceable flat-end members 128 (see FIG. 10).

### Fifth Embodiment

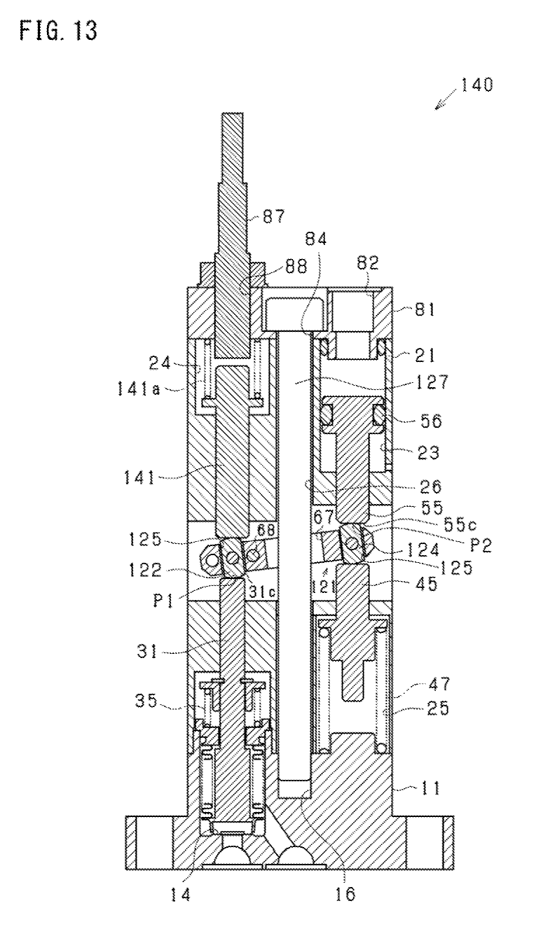

Next, a lever type switching valve 140 according to a fifth embodiment will be described with reference to FIG. 13. The lever type switching valve 140 of the fifth embodiment is configured to be a normally closed switching valve. In the fifth embodiment also, members corresponding to those of the first to fourth embodiments are denoted by the same reference numerals, and description thereof is omitted.

In the lever type switching valve 140 of the fifth embodiment, an urging force of the compression spring 47 (second urging mechanism) provided in the second auxiliary chamber 25 urges the valve rod 31 toward the valve seat section 14. That is, the lever type switching valve 140 is held in a fully closed condition mainly by an urging force of the compression spring 47, and the first urging mechanism is not provided in the first auxiliary chamber 24.

An urging force of the compression spring 47 provided in the second auxiliary chamber 25 is amplified through the lever member 121 and is then applied to the valve rod 31. Thus, by means of only an urging force of the compression spring 47, a sufficiently large force is applied to the valve rod 31, whereby the lever type switching valve 140 can be reliably held in a fully closed condition.

The lever type switching valve 140 has the position sensor 87 inserted in the insertion hole 88 of the cover 81. A detection object 141 is provided within the first auxiliary chamber 24 as an object to be detected by the position sensor 87. The position sensor 87 is provided in such a manner as to reciprocally move in the first auxiliary chamber 24. Also, an auxiliary spring 141a is provided within the first auxiliary chamber 24 and urges the detection object 141 toward the lever member 121. An urging force of the auxiliary spring 141a is smaller than that of the compression spring 47. An urging force of the auxiliary spring 141a functions to move the detection object 141 straight toward the lever member 121 (downward in FIG. 13). That is, the auxiliary spring 141a applies a relatively small urging force to the detection object 141 so that the detection object 141 moves stably toward the lever member 121.

An end portion (lower end portion in FIG. 13) of the detection object 141 located toward the lever member 121 protrudes from the first auxiliary chamber 24 and is in contact (point contact) with the columnar member 122 of the lever member 121. The detection object 141 reciprocates with swinging of the lever member 121.

The position sensor 87 detects the position of the detection object 141, thereby detecting the position of the valve rod 31. Thus, the position of the valve rod 31 and, in turn, valve opening can be detected.

The present embodiment described above in detail has the following advantages. The following description discusses only advantages different from those of the first to fourth embodiments.
Since the lever type switching valve 140 is held in a fully closed condition only by an urging force of the second urging mechanism (compression spring 47) provided in the second auxiliary chamber 25, there is no need to provide, within the first auxiliary chamber 24, the large compression springs 40 and 41 which constitute the first urging mechanism employed in the first embodiment. Accordingly, the number of components is smaller than in the case of the first embodiment, whereby the product cost can be reduced. Also, since an urging force of the second urging mechanism is amplified through the lever member 121 and is then applied to the valve rod 31, even the second urging mechanism can apply a sufficient force to the valve rod 31.
The detection object 141 is provided in the first auxiliary chamber 24, and the position sensor 87 detects the position of the detection object 141. Thus, even though the position of the valve rod 31 is not directly detected, valve opening can be detected. The first urging rod 39 employed in the first embodiment can be utilized as the detection object 141. In this case, components can be used in common, whereby the product cost and the development cost can be restrained.

In the modified embodiment shown in FIG. 5, the position sensor 87 detects the position of the first urging rod 39, whereas in the fifth embodiment, the position sensor 87 detects the position of the detection object 141. However, an object which the position sensor 87 detects is not limited to the first urging rod 39 and the detection object 141, but another member may be used as the object of detection.

For example, the position sensor 87 may directly detect the position of the valve rod 31. Also, the position sensor 87 may detect the position of the piston rod 55 or 129 or the position of the second urging rod 45, thereby estimating the position of the valve rod 31 from the result of the detection. Furthermore, the position sensor 87 may detect the angle of inclination of the lever member 60 or 121, thereby estimating the position of the valve rod 31. In the case of employment of the piston rod 55 or 129, the second urging rod 45, or the lever member 60 or 121 as an object of detection, the result of detection needs to be converted by use of a predetermined conversion equation for estimating the position of the valve rod 31.

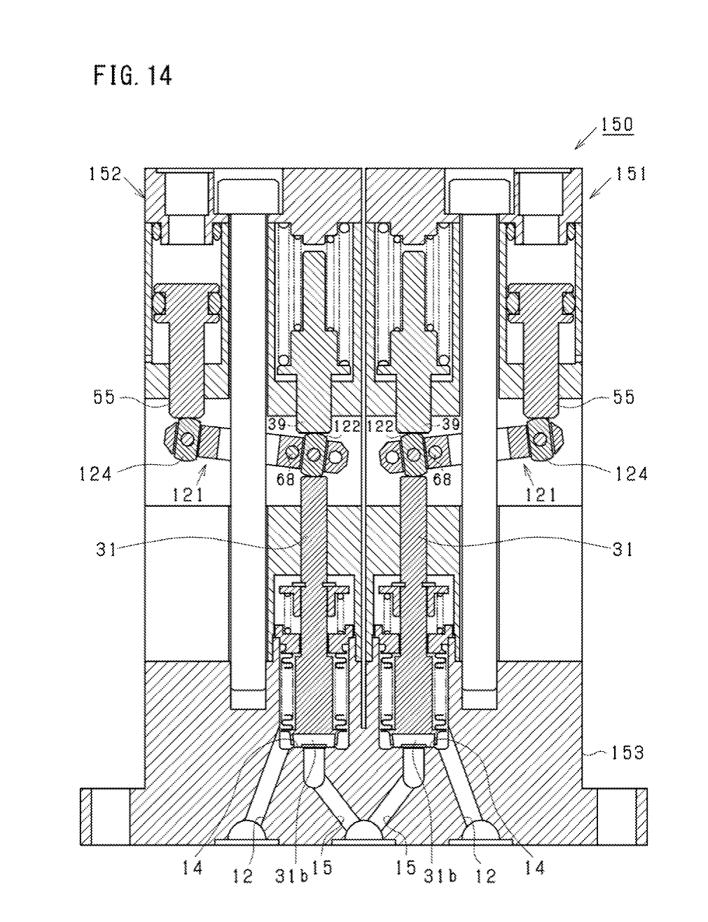

The present invention is not limited to the above embodiments and can be embodied, for example, as follows. Members corresponding to those of the above embodiments are denoted by the same reference numerals, and description thereof is omitted.
In the above embodiments, the lever type switching valves are configured to switch over the condition of communication between the inlet flow passage 12 and the outlet flow passage 15 by the single valve rod 31 from a communicating condition to a shutoff condition, and vice versa. However, for example, as shown in FIG. 14, the lever type switching valve may be configured to be a three-way valve 150. That is, in the three-way valve 150 of FIG. 14, two valve rods 31 are used to switch over the condition of communication between two sets of the inlet flow passages 12 and the outlet flow passages 15.

Specifically, the three-way valve 150 is disposed, in parallel, with a first switching valve 151 configured similar to the lever type switching valve 120 shown in FIG. 8, and a second switching valve 152 configured to be a mirror image of the lever type switching valve 120 with respect to the reciprocating direction of the valve rod 31 (vertical direction in FIG. 14). In the three-way valve 150, a single flow passage block 153 is used in common between the first switching valve 151 and the second switching valve 152. The flow passage block 153 is formed into a thin rectangular-parallelepiped shape from, for example, stainless steel having chemical resistance. In the flow passage block 153, depth (direction of the support shafts 68) is smaller as compared with width (horizontal length in FIG. 14). Thus, the thin three-way valve 150 having a small depth can be implemented.

The flow passage block 153 has a set consisting of the inlet flow passage 12 and the outlet flow passage 15 for each of the first switching valve 151 and the second switching valve 152. The inlet flow passages 12 open at the lower surface of the flow passage block 153. By contrast, the two outlet flow passages 15 join together at a common opening portion which opens at the lower surface of the flow passage block 153.

Through respective reciprocation of the valve rods 31 of the first switching valve 151 and the second switching valve 152, the condition of communication between the inlet flow passage 12 and the outlet flow passage 15 of each set can be controlled. In the case where both of the first switching valve 151 and the second switching valve 152 are fully opened, process gases flowing through the two outlet flow passages 15 merge at and are discharged from the lower surface of the flow passage block 153. In the case where either of the first switching valve 151 and the second switching valve 152 is fully opened, and the other one is fully closed, process gas is discharged from only the fully opened switching valve.
In the first to fourth embodiments, the drive chamber 23 is located opposite the operation chamber 13 with respect to the swing chamber 22. However, the drive chamber 23 may be provided on the same side as the operation chamber 13 with respect to the swing chamber 22 (i.e., at the position of the second auxiliary chamber 25 in the first to fourth embodiments). In this case, the second auxiliary chamber 25 is provided at the position of the drive chamber 23 in the first to fourth embodiments.
In the lever type switching valves 10 and 110 of the first and second embodiments, there can be eliminated the clearance (second clearance) formed between the bush 36 and the valve rod 31 and adapted to allow inclination of the valve rod 31 in relation to the bush 36. In this case, it will suffice to slidably support the valve rod 31 by the bush 36.
In the first and second embodiments, in a condition in which the switching valves 10 and 110 are opened (in a fully opened condition), there can be eliminated the clearance (first clearance) between the valve rod 31 and the steel ball 69 of the lever member 60. That is, in a condition in which the switching valve 10 is opened (in a fully opened condition), the valve rod 31 and the steel ball 69 of the lever member 60 can be in contact with each other.
In the first and second embodiments, the first and second holes 63 and 65 into which the steel balls 69 and 70 are press-fitted can be formed in such a manner as to extend through the lever member 60 in the height direction.
The contact members are not necessarily provided rotatably or in a swingable manner in the lever members 60 and 121. In contrast to the steel balls 69 and 70 and the columnar members 122 and 124, the contact members are not necessarily formed separately from the lever members 60 and 121, but may be formed integrally with the lever members 60 and 121. The contact members are not limited to the steel balls 69 and 70 and the columnar members 122 and 124 so long as at least a portion of contact with the valve rod 31 or the piston rod 55 or 129 has an arcuate cross section, such as a spherical surface or a circular columnar surface. For example, the contact member may have an elliptical section or a diamond section having radiused edges.

The columnar members 122 and 124 in the third embodiment are configured such that opposite end portions of a circular columnar body are formed hemispherical; however, the columnar members 122 and 124 are not limited thereto. For example, the columnar members 122 and 124 may be configured such that opposite end portions of a rectangular columnar body are formed semicylindrical. In this case, opposite end portions of the columnar members 122 and 124 respectively have cylindrical surfaces. The cylindrical surfaces of the columnar members 122 and 124 are in a line contact with the valve rod 31, the piston rod 55, etc., in the direction of the support shaft 68. In this manner, even though opposite end portions of the columnar members 122 and 124 respectively have cylindrical surfaces, the amount of contact with the valve rod 31, the piston rod 55 or others is restrained. As a result, a frictional force generated between the columnar member 122 or 124 and the valve rod 31 or the piston rod 55 can be reduced.

Furthermore, roller-shaped cylindrical members may be employed as contact members. In this case, the contact members in the form of the cylindrical members are supported rotatably by the lever members 60 and 121 through respective axles extending in the same direction as the support shaft 68. The contact members are configured such that their cylindrical surfaces are in a line contact with the valve rod 31, the piston rod 55 or others, in the direction of the support shaft 68. In this manner, even though the cylindrical members are employed as the contact members, the amount of contact with the valve rod 31, the piston rod 55 or others is restrained. Thus, a frictional force generated between the contact member and the valve rod 31 or the piston rod 55 can be reduced.
In place of a configuration in which working air drives the piston rods 55 and 129, there can be employed a configuration in which a feed screw drives the piston rod 55 and 129. In this case, the feed screw may be operated manually or driven by a motor.
The flowing direction of process gas can be opposite that of the above embodiments. Specifically, process gas can flow in through the outlet flow passage 15 and can flow out through the inlet flow passage 12.
The lever type switching valves 10, 110, 120, 130, 140 and 150 can also be used to switch over the condition of a flow passage of liquid, such as chemical liquid, between a communicating condition and a shutoff condition.

From the above embodiments, the following technical ideas can be specified.

1. In the lever type switching valve according to the tenth implementation, the lever member has a hole into which the sphere is press-fitted, and an engagement hole which communicates with the hole and with which a portion of the sphere is engaged.

According to the above configuration, when the sphere is press-fitted into the hole (first hole, second hole) of the lever member, a portion of the sphere can be engaged with the engagement hole which communicates with the hole. Thus, the sphere can be readily positioned in relation to the lever member. Particularly, the above configuration is effective for the case where the switching valve is thin and employs a small-sized lever member.

2. In the lever type switching valves according to the first to thirteenth implementation, in a condition in which the lever member is pivotally moved to a greatest extent toward a side away from the valve rod, the first clearance is formed between the lever member and the valve rod.

In the lever type switching valve in which the valve rod, the lever member, and the piston rod operate in a cooperating manner, as a result of accumulation of manufacturing errors of these members, a stroke for separating the valve rod from the valve seat section may fail to be appropriately secured.

In this connection, according to the above configuration, in a condition in which the lever member is pivotally moved to a greatest extent toward a side away from the valve rod, the first clearance is formed between the lever member and the valve rod. Thus, even though manufacturing errors of the valve seat section, the valve rod, the lever member, and the piston rod are accumulated, a stroke for separating the valve rod from the valve seat section can be appropriately secured.

3. In the lever type switching valves according to the first to thirteenth implementation, the body has the sliding contact member which slidably supports the valve rod in the course of reciprocation of the valve rod, and the second clearance is formed between the sliding contact member and the valve rod.

According to the above configuration, in the course of reciprocation of the valve rod, the sliding contact member provided in the body slidably supports the valve rod. Furthermore, since the second clearance is formed between the sliding contact member and the valve rod, the second clearance allows some inclination of the valve rod in relation to the sliding contact member in the course of reciprocation of the valve rod. As a result, the valve rod comes into contact with the valve seat section while following the profile of the valve seat section; thus, even though manufacturing errors of the valve seat section and the valve rod exist, the valve rod and the valve seat section can be appropriately brought into contact with each other.

4. In the lever type switching valves according to the first to thirteenth implementation, the body includes the flow passage block in which the flow passages are provide, and the case in which the swing chamber is provided; the case has the attachment hole extending across the swing chamber at a position located between the operation chamber and the drive chamber with respect to the extending direction of the swing chamber and opening at the end surface of the case, and the insertion hole communicating with the attachment hole and allowing insertion of a fastening member into the case; the lever member has the through hole formed at a position which faces the attachment hole; and the flow passage block and the case are fastened together with the fastening member.

According to the above configuration, the case has the attachment hole extending across the swing chamber at a position located between the operation chamber and the drive chamber with respect to the extending direction of the swing chamber and opening at the end surface of the case. The insertion hole which allows insertion of the fastening member into the case communicates with the attachment hole. Thus, the fastening member can be inserted into the case through the insertion hole and disposed at a position which faces the attachment hole. Also, the lever member has the through hole formed at a position which faces the attachment hole. Thus, the fastening member can be tightened by use of a tool inserted through the attachment hole and through the through hole of the lever member. As a result, there is no need to extend the fastening member to near the surface of the case, whereby an increase in the length of the fastening member can be restrained.

5. In the lever type switching valves according to the first to thirteenth implementation, the body has the first auxiliary chamber provided on a side opposite the operation chamber with respect to the swing chamber and extending rectilinearly; the first urging mechanism having the first urging rod is provided within the first auxiliary chamber; the first urging mechanism reciprocates the first urging rod in the extending direction of the first auxiliary chamber and urges the lever member toward the valve rod through the first urging rod; and the position sensor is inserted into the first auxiliary chamber for detecting the position of the first urging rod.

According to the above configuration, the first urging mechanism having the first urging rod is provided within the first auxiliary chamber. Also, the first urging mechanism reciprocates the first urging rod in the extending direction of the first auxiliary chamber and urges the lever member toward the valve rod through the first urging rod. Reciprocation of the first urging rod swings the lever member, and swinging of the lever member reciprocates the valve rod. Thus, the position of the valve rod varies with the position of the first urging rod. Therefore, through detection of the position of the first urging rod by the position sensor inserted into the first auxiliary chamber, the position of the valve rod and, in turn, valve opening can be detected. That is, through utilization of the first urging rod which urges the lever member toward the valve rod, valve opening can be detected.

Furthermore, the first auxiliary chamber is provided on a side opposite the operation chamber with respect to the swing chamber; i.e., on the same side as the drive chamber with respect to the swing chamber. Thus, the position sensor and a mechanism for driving the piston rod can be disposed on the same side, whereby spaces required for disposing the mechanism and the sensor can be reduced.

What is claimed is:

1. A lever type switching valve comprising:
a body having a flow passage of fluid, a valve seat section, an operation chamber, a swing chamber and a drive chamber inside the body, the operation chamber facing the valve seat section and extending rectilinearly, the swing chamber extending to intersect with the operation chamber at an end of the operation chamber located opposite the valve seat section, the drive chamber extending rectilinearly to intersect with the swing chamber at a position offset from an extension of the operation chamber, and the operation chamber, the swing chamber and the drive chamber extending along a reference plane;
a valve rod inserted into the operation chamber and adapted to reciprocate in an extending direction of the operation chamber to come into contact with and separate from the valve seat section;
a piston rod inserted into the drive chamber and adapted to reciprocate in an extending direction of the drive chamber; and
a lever member accommodated within the swing chamber and having a fulcrum member, wherein
the lever member is configured that a distance between the fulcrum member and a second contact position where the piston rod and the lever member come into contact with each other is longer than a distance between the fulcrum member and a first contact position where the valve rod and the lever member come into contact with each other, and
reciprocation of the piston rod swings the lever member about the fulcrum member, and swinging of the lever member reciprocates the valve rod.

2. The lever type switching valve according to claim 1, wherein
the drive chamber is provided at a position located on a side opposite the operation chamber with respect to the swing chamber and offset from the extension of the operation chamber;
the fulcrum member is provided in the lever member between the first contact position and the second contact position;
the body has a first auxiliary chamber provided on a side opposite the operation chamber with respect to the swing chamber; and
a first urging mechanism for urging the lever member toward the valve rod is provided within the first auxiliary chamber.

3. The lever type switching valve according to claim 1, wherein
the drive chamber is provided at a position located on a side opposite the operation chamber with respect to the swing chamber and offset from an extension of the operation chamber;
the fulcrum member is provided in the lever member between the first contact position and the second contact position;
the body has a second auxiliary chamber provided on a side opposite the drive chamber with respect to the swing chamber; and
a second urging mechanism for urging the lever member toward the piston rod is provided within the second auxiliary chamber.

4. The lever type switching valve according to claim 2, wherein
a third urging mechanism for urging the valve rod toward the lever member is provided within the operation chamber;
the lever member is configured to allow changeover of position of the fulcrum member to a position located opposite the second contact position with respect to the first contact position;
the body has a second auxiliary chamber provided on a side opposite the drive chamber with respect to the swing chamber;
a second urging mechanism for urging the lever member toward the piston rod is provided within the second auxiliary chamber; and
the first urging mechanism is configured to be detachable.

5. The lever type switching valve according to claim 1, wherein
the drive chamber is provided at a position located on a side opposite the operation chamber with respect to the swing chamber and offset from an extension of the operation chamber;
a third urging mechanism for urging the valve rod toward the lever member is provided within the operation chamber; and
the fulcrum member is provided in the lever member on a side opposite the second contact position with respect to the first contact position.

6. The lever type switching valve according to claim 1, wherein
the lever member has a contact member of which at least a portion in contact with the valve rod has an arcuate cross section and is in point or line contact with the valve rod.

7. The lever type switching valve according to claim 6, wherein
the valve rod has a first flat portion perpendicular to a reciprocating direction of the valve rod and in contact with the contact member.

8. The lever type switching valve according to claim 1, wherein
the lever member has a contact member of which at least a portion in contact with the piston rod has an arcuate cross section and is in point or line contact with the piston rod.

9. The lever type switching valve according to claim 8, wherein
the piston rod has a second flat portion perpendicular to a reciprocating direction of the piston rod and in contact with the contact member.

10. The lever type switching valve according to claim 6, wherein the contact member is a sphere provided rotatably in the lever member.

11. The lever type switching valve according to claim 6, wherein
the contact member is a columnar member which is provided in the lever member to be rotatable about an axis in parallel with an axis of the fulcrum member and whose opposite end portions have respective arcuate cross sections.

12. The lever type switching valve according to claim 1, further comprising:
a slide which is provided within the drive chamber and is slid toward the lever member by a drive force;
a stopper which comes into contact the slide slid by the drive force to stop the slide; and
an urging member which is elastically deformable in an extending direction of the piston rod and connects the slide and the piston rod;
wherein in a condition in which the slide is stopped by the stopper, an elastic force of the urging member urges the piston rod toward the lever member.

13. The lever type switching valve according to claim 1, wherein
the body has a position sensor configured to detect or estimate the position of the valve rod.
